(19) United States
(12) Patent Application Publication
(10) Pub. No.: US 2026/0252649 A1
(43) Pub. Date: Aug. 27, 2026

(54) SYSTEM

(71) Applicant: SoftBank Group Corp., Tokyo (JP)

(72) Inventor: Mitsue ECHIZEN, Tokyo (JP)

(73) Assignee: SoftBank Group Corp., Tokyo (JP)

(21) Appl. No.: 19/536,297

(22) Filed: Feb. 11, 2026

(30) Foreign Application Priority Data
Feb. 21, 2025 (JP) 2025-027090

(51) Int. Cl. G06F 16/9535; G06F 40/30; G10L 15/06

(52) U.S. Cl. CPC G06F 16/9535; G06F 40/30; G10L 15/063

(57) ABSTRACT

The system according to the embodiment comprises a collection unit, an analysis unit, and an estimation unit. The collection unit collects a person's utterances in real time. The analysis unit analyzes utterance data collected by the collection unit. The estimation unit estimates the person's intention based on information analyzed by the analysis unit.

### CROSS-REFERENCE TO RELATED APPLICATION

The present application claims priority to and incorporates by reference the entire contents of Japanese Patent Application No. 2025-027090 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to accurately grasp a person's intention when cognitive impairment occurs.

### SUMMARY OF THE INVENTION

The system according to the embodiment comprises a collection unit, an analysis unit, and an estimation unit. The collection unit collects a person's utterances in real time. The analysis unit analyzes utterance data collected by the collection unit. The estimation unit estimates the person's intention based on information analyzed by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

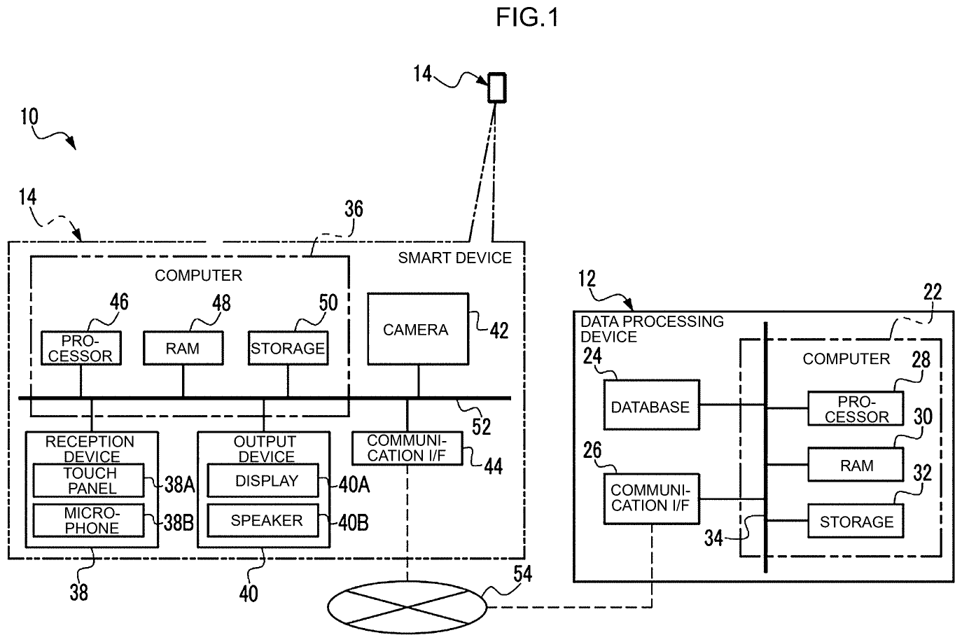

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

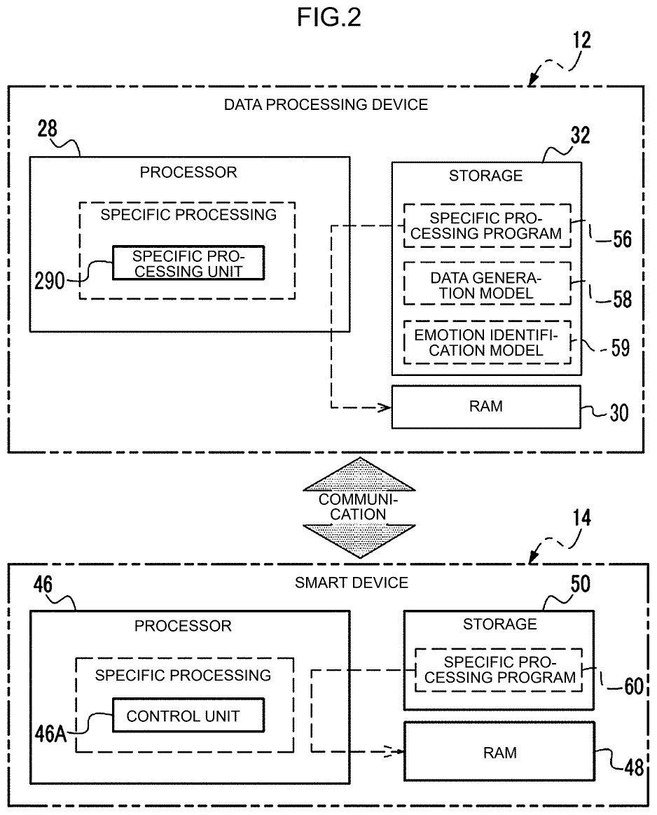

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a wearable device for grasping a person's intention in the event of cognitive impairment. This wearable device collects the person's utterances in real time, and the collected utterance data is analyzed by a generative AI to extract trends and meanings of words. Furthermore, the person's intention is estimated based on the extracted information. The device also implements lifelog recording and a wandering prevention function, supporting the person's overall daily life. For example, the wearable device collects the person's utterances in real time. Next, the collected utterance data is analyzed by a generative AI to extract trends and meanings of words. Furthermore, the person's intention is estimated based on the extracted information. The device also implements lifelog recording and a wandering prevention function, supporting the person's overall daily life. As a result, the wearable device can grasp the person's intention even if cognitive impairment occurs. Specifically, the wearable device is equipped with multiple sensor groups such as a microphone for voice input, an accelerometer, a GPS module, and vital sensors, and acquires the person's spoken voice as 16 kHz sampled PCM data in real time. The system first converts the speech audio data into a spectrogram, applies noise reduction processing, and then inputs it into a speech recognition engine (e.g., a Transformer-based end-to-end speech recognition model). The speech recognition engine takes the audio waveform tensor (e.g., 1 second of data with a length of 16000×1) as input and generates a sequence of utterance texts (e.g., “I want to go for a walk today”). Next, the system inputs the utterance text into a large language model (e.g., a pre-trained Transformer-type LLM) to extract the intention, emotion, and topic of the utterance. Examples of input include natural language sentences such as “I want to go for a walk today,” “I'm hungry,” and “I don't know where I am.” The large language model outputs structured data such as intention labels (e.g., desire to go out, request for food, feeling of anxiety), emotion scores (e.g., joy 0.8, anxiety 0.6), and topic categories (e.g., health, movement, food). Furthermore, the estimation module estimates the person's current intention (e.g., wants to go out, wants to eat, is seeking help) based on these output values. The estimation results are used for threshold judgment and rule-based branching processing (e.g., if the anxiety score is 0.7 or higher, notify the family). The lifelog recording function records the person's activity history (e.g., number of steps, movement route, utterance content, emotional transitions) in a time-series database, and the wandering prevention function combines GPS location information and behavior pattern analysis (e.g., detection of deviation from normal routes) to issue alerts in the event of abnormal behavior. As a technical effect, the system realizes high-frequency and high-precision utterance analysis and intention estimation, which are difficult with mere human observation or recording, by utilizing the multilayered feature extraction and pattern recognition capabilities of AI models, thereby greatly improving the accuracy of grasping the intentions of persons with cognitive impairment. In addition, real-time processing and automated data linkage enable reduction of caregiver burden and prompt response. Application fields include monitoring of dementia patients, home care support, grasping patient intentions in medical settings, and support facilities for persons with disabilities. Furthermore, the collaboration of multiple AI models (speech recognition, natural language understanding, emotion estimation, behavior prediction) enables multifaceted life support that could not be achieved with conventional single-function devices, which is also an important technical feature of the present invention.

The system according to the embodiment comprises a collection unit, an analysis unit, and an estimation unit. The collection unit collects the person's utterances in real time. For example, the collection unit can collect the person's utterances as audio data. The collection unit can also collect the person's utterances as text data. Furthermore, the collection unit can collect the person's utterances as gesture data. The analysis unit analyzes utterance data collected by the collection unit. For example, the analysis unit can convert audio data into text data using speech recognition technology. The analysis unit can also analyze text data using text analysis technology. Furthermore, the analysis unit can analyze the emotion of utterance data using emotion analysis technology. The estimation unit estimates the person's intention based on information analyzed by the analysis unit. For example, the estimation unit can estimate the person's decision-making based on the analysis results. The estimation unit can also estimate the person's emotional state based on the analysis results. Furthermore, the estimation unit can estimate the person's behavioral intention based on the analysis results. Thus, the system according to the embodiment can collect, analyze, and estimate the intention of the person's utterances in real time. Specifically, the system is equipped with a high-sensitivity microphone array, IMU sensors, touch sensors, etc. as the collection unit, and acquires audio data (e.g., 16 kHz, 16 bit, monaural PCM), text data (e.g., chat app input history), and gesture data (e.g., 3-axis acceleration values, posture estimation vectors) in a time series. The collection unit buffers these data and transfers them to the analysis unit at regular intervals. The analysis unit converts audio data into spectrograms, inputs them into a Transformer-type speech recognition model, and generates a sequence of utterance texts (e.g., “I want to drink water”) as output. For text data, natural language processing algorithms such as morphological analysis, named entity extraction, and dependency structure analysis are applied to extract the topic, intention, and emotional words of the utterance. For gesture data, time-series convolutional neural networks (TCN) or LSTM are used to classify motion patterns (e.g., wandering, sitting, walking initiation). As emotion analysis technology, BERT-based emotion classification models and multimodal emotion estimation models are used, with utterance text and audio features (e.g., F0, energy, spectral envelope) as input, and emotion labels (e.g., joy, anger, anxiety) and emotion intensity scores (e.g., 0.7, 0.2, 0.1) as output. The estimation unit inputs features such as topic, intention, emotion, and motion pattern obtained from the analysis unit into estimation algorithms such as multilayer perceptrons or decision trees to estimate the person's decision-making (e.g., desire to go out, request for rest), emotional state (e.g., calmness, anxiety), and behavioral intention (e.g., initiation of movement, seeking help). The estimation results are used for threshold judgment and rule-based branching processing (e.g., notify family if the anxiety score is high). As a technical effect, the system integrally analyzes multimodal data and achieves more accurate and robust estimation than conventional intention estimation relying on a single data source. In addition, real-time processing enables support that promptly responds to changes in the person's state. Application fields include monitoring of dementia patients, support for persons with disabilities, grasping patient intentions in medical settings, and home care. Furthermore, by disclosing the details of internal AI model processing (feature extraction, classification, estimation), the system eliminates the ambiguity of black-box processing and clarifies the basis for technical improvement.

The system comprises a recording unit configured to record lifelogs. The recording unit records lifelogs to support the person's overall daily life. For example, the recording unit can record the person's activity history. The recording unit can also record the person's health data. Furthermore, the recording unit can record the person's location information. By recording lifelogs, the person's overall daily life can be supported. Specifically, the recording unit records time-series data such as the number of steps, travel distance, calories burned, and sleep time as activity history in one-minute intervals. For health data, vital data such as heart rate, blood pressure, body temperature, and blood oxygen saturation are acquired via Bluetooth and recorded every 10 seconds. Location information is obtained from the GPS module every 5 seconds, including latitude, longitude, altitude, and travel speed, and recorded with timestamps. The recording unit structures these data as a time-series database (e.g., tuples of time, data type, and value), and automatically performs data compression and anomaly detection (e.g., flagging when travel speed is abnormally high). Furthermore, the recording unit links and records utterance content and emotion estimation results (e.g., utterance text, emotion score) to the lifelog. Recorded data are automatically backed up to a cloud server or local storage and can be accessed by family members or medical professionals as needed. As a technical effect, the recording unit enables multifaceted understanding of the person's living conditions by integrally and frequently recording multiple biometric, behavioral, and utterance data, compared to conventional manual recording or recording of a single data type. This enables early detection of abnormal behavior, improved accuracy of health management, and optimization of care planning. Application fields include monitoring of dementia patients, home care, health management applications, and medical data linkage platforms. Furthermore, the recording unit has extensibility to dynamically change recording frequency and data types according to the person's state or external instructions, allowing flexible adaptation to future functional additions.

The system comprises a prevention unit configured to implement a wandering prevention function. The prevention unit implements a wandering prevention function to ensure the person's safety. For example, the prevention unit is equipped with a location tracking function and can track the person's location in real time. The prevention unit is also equipped with an alert notification function and can issue alerts when the person leaves a specific area. Furthermore, the prevention unit is equipped with a behavior restriction function and can restrict the person's behavior. By implementing a wandering prevention function, the person's safety can be ensured. Specifically, the prevention unit uses GPS modules and Wi-Fi/Bluetooth beacons to obtain the person's current location (latitude, longitude, altitude) every 5 seconds and determines the positional relationship with a pre-set safe area (e.g., a 200 m radius around the home). If the person deviates from the safe area, the prevention unit immediately sends an alert signal (e.g., vibration, voice guidance, smartphone notification) to the person and caregiver terminals. As a behavior restriction function, if the person approaches a dangerous area (e.g., roadway, station premises), the system provides warnings via speech synthesis or automatically notifies the family. Furthermore, the prevention unit analyzes the person's travel speed and movement patterns (e.g., deviation from normal routes, going out late at night) in a time series, calculates a wandering risk score when abnormal behavior is detected, and executes additional actions (e.g., automatic contact with a security company) when the threshold is exceeded. As a technical effect, the prevention unit combines real-time location and behavior analysis with multi-stage alert and restriction functions to achieve more accurate and rapid wandering prevention than conventional simple location notification systems. Application fields include monitoring of dementia patients, support for persons with disabilities, child safety management, and wandering countermeasures in medical and care facilities. Furthermore, the prevention unit has extensibility to apply individually optimized prevention algorithms by linking with the person's behavior history and emotional state.

The collection unit is configured to estimate the person's emotion and adjust the timing of utterance collection based on the estimated emotion. For example, if the person is relaxed, the collection unit can increase the frequency of utterance collection. If the person is feeling stressed, the collection unit can decrease the frequency of utterance collection. Furthermore, if the person is excited, the collection unit can adjust the timing of utterance collection to avoid missing important utterances. By adjusting the timing of utterance collection according to the person's emotion, important utterances can be collected without omission. Emotion estimation is realized using an emotion engine or generative AI, such as a text generation AI (e.g., LLM) or multimodal generative AI, but is not limited to these examples. Specifically, the collection unit acquires the person's spoken voice and text data in real time and inputs them into an emotion estimation module. The emotion estimation module uses a BERT-based emotion classification model or a multimodal emotion estimation model, with utterance text (e.g., “I'm having fun today,” “I'm already tired”) and audio features (e.g., F0, energy, spectral envelope) as input, and generates emotion labels (e.g., relaxed, stressed, excited) and emotion intensity scores (e.g., relaxed 0.8, stressed 0.2) as output. The collection unit dynamically sets collection frequency parameters (e.g., 1-minute intervals when relaxed, 5-minute intervals when stressed, 30-second intervals when excited) based on the emotion intensity scores. For example, when the person is relaxed, the system emphasizes the natural flow of conversation and collects utterances at a high frequency; when stressed, it reduces the collection frequency to avoid excessive intervention; and when excited, it collects utterances at short intervals to avoid missing important utterances or signs of abnormal behavior. Examples of input for emotion estimation include “I'm feeling good today,” “I want help,” “I don't know where I am,” and examples of output include emotion labels: relaxed, stressed, excited, and emotion intensity scores: 0.7, 0.2, 0.1. The collection unit implements an algorithm (e.g., threshold judgment, PID control) to automatically adjust collection timing and frequency based on these output values. As a technical effect, the collection unit optimizes collection timing according to the person's emotional state, enabling high-precision and efficient collection of important utterances and signs of abnormality. This greatly improves information coverage and system responsiveness compared to conventional fixed-interval collection methods. Application fields include monitoring of dementia patients, monitoring of patients with mental disorders, and home care support. Furthermore, by changing the type and parameters of the emotion estimation model, individual optimization and application to diverse use cases are possible.

The collection unit is configured to analyze the person's past utterance history and select an appropriate collection method. For example, the collection unit can set the collection timing based on the time periods when the person frequently uttered in the past. The collection unit can also analyze the content of past utterances and preferentially collect important utterances. Furthermore, the collection unit can optimize the collection method based on past utterance patterns. By analyzing past utterance history, the collection unit can select the optimal collection method. Specifically, the collection unit maintains a time-series database of the person's utterance history for the past week to month (e.g., utterance time, utterance content, emotion score, utterance length), and uses time-series clustering or autoregressive models (AR models) to automatically extract peak time periods of utterance frequency (e.g., 9:00-10:00 a.m., 7:00-8:00 p.m.). The collection unit schedules increased collection frequency during extracted peak time periods and reduces collection frequency during non-peak periods. For utterance content, the system calculates importance scores using TF-IDF or BERT embedding vectors and preferentially collects and records utterances with high importance (e.g., “Help,” “I want to go outside”). For utterance pattern analysis, time-series models such as HMM (Hidden Markov Model) or LSTM are used to detect periodicity or abnormal patterns in utterances (e.g., frequent utterances late at night), and the collection method (e.g., collection interval, collection mode) is automatically switched when abnormal patterns occur. As a technical effect, the collection unit analyzes past utterance history with AI models and dynamically optimizes collection timing and methods, greatly improving information coverage and efficiency compared to conventional fixed schedule methods. Application fields include monitoring of dementia patients, monitoring of patients with mental disorders, home care support, and grasping patient status in medical settings. Furthermore, by optimizing analysis algorithms and parameters for each individual, the collection unit can realize personalized collection strategies.

The collection unit is configured to perform filtering at the time of utterance collection based on the person's living conditions and areas of interest. For example, the collection unit can preferentially collect utterances related to topics the person is currently interested in. The collection unit can also adjust the content of utterances to be collected according to the person's living conditions. Furthermore, the collection unit can filter and collect utterances related to the person's current activity. By filtering utterances based on the person's living conditions and areas of interest, highly relevant utterances can be collected. Specifically, the collection unit acquires the person's living conditions data (e.g., current activity type, location information, health status) and areas of interest data (e.g., recent search history, conversation history, hobby preference profile), and matches them with utterance content. Utterance content is vectorized using natural language embedding models such as BERT, and the cosine similarity with the areas of interest vector is calculated to obtain a relevance score. The collection unit preferentially collects and records only utterances with a relevance score above a threshold. For example, if the person is interested in “gardening,” utterances containing keywords such as “flowers,” “garden,” or “plants” are preferentially collected. For adjustment according to living conditions, utterances related to exercise are prioritized when the person is exercising, and utterances related to meals are prioritized when the person is eating. Current activity is estimated from accelerometer sensors or location information, and the collection filter is switched for each activity type (e.g., walking, resting, eating). As a technical effect, the collection unit efficiently acquires highly relevant information by dynamic filtering based on the person's living conditions and areas of interest, compared to conventional indiscriminate collection methods. Application fields include monitoring of dementia patients, personalized health management, home care support, and life support robots. Furthermore, by changing the filtering algorithm or relevance calculation method, the system can flexibly respond to diverse use cases.

The collection unit is configured to estimate the person's emotion and determine the priority of utterances to be collected based on the estimated emotion. For example, if the person is relaxed, the collection unit can preferentially collect daily utterances. If the person is feeling stressed, the collection unit can preferentially collect emotional utterances. Furthermore, if the person is excited, the collection unit can preferentially collect important utterances. By determining the priority of utterances to be collected according to the person's emotion, important utterances can be preferentially collected. Emotion estimation is realized using an emotion engine or generative AI, such as a text generation AI (e.g., LLM) or multimodal generative AI, but is not limited to these examples. Specifically, the collection unit acquires the person's spoken voice and text data in real time and inputs them into an emotion estimation module. The emotion estimation module uses a BERT-based emotion classification model or a multimodal emotion estimation model, with utterance text (e.g., “I'm having fun today,” “I'm already tired”) and audio features (e.g., F0, energy, spectral envelope) as input, and generates emotion labels (e.g., relaxed, stressed, excited) and emotion intensity scores (e.g., relaxed 0.8, stressed 0.2) as output. The collection unit calculates utterance priority scores based on emotion labels and intensity scores. For example, daily utterances (e.g., “The weather is nice today”) are prioritized when relaxed, emotional utterances (e.g., “Help,” “I can't take it anymore”) are prioritized when stressed, and important utterances (e.g., “I want to go outside,” “I don't know where I am”) are prioritized when excited. Priority scores are calculated in combination with importance estimation using TF-IDF scores or BERT embedding vectors of utterance content, and the top N utterances are transferred to the recording and analysis units. As a technical effect, the collection unit dynamically optimizes the priority of utterances to be collected according to the person's emotional state, greatly improving information coverage and system responsiveness compared to conventional uniform collection methods. Application fields include monitoring of dementia patients, monitoring of patients with mental disorders, and home care support. Furthermore, by changing the emotion estimation model or priority calculation algorithm, individual optimization and application to diverse use cases are possible.

The collection unit is configured to preferentially collect highly relevant utterances at the time of utterance collection based on the person's geographic location information. For example, if the person is in a specific place, the collection unit can preferentially collect utterances related to that place. If the person is moving, the collection unit can preferentially collect utterances related to the destination. Furthermore, if the person is in a specific region, the collection unit can preferentially collect utterances related to that region. By considering geographic location information, highly relevant utterances can be preferentially collected. Specifically, the collection unit uses location detection sensors such as GPS modules and Wi-Fi/Bluetooth beacons to obtain the person's current location (latitude, longitude, altitude) every 5 seconds and records the location information in a time-series database. When collecting speech audio data or text data, the collection unit links location information with utterance content. Utterance content is vectorized using natural language embedding models such as BERT, and the cosine similarity with topic vectors linked to location information (e.g., place categories such as hospital, supermarket, park) is calculated to obtain a relevance score between utterance and place. The collection unit implements an algorithm to preferentially collect and record only utterances with a relevance score above a threshold. For example, if the person is in a hospital, utterances containing keywords such as “examination,” “medicine,” or “waiting time” are preferentially collected; if in a supermarket, utterances such as “shopping,” “cart,” or “checkout” are prioritized. When moving, utterances related to predicted destinations (e.g., on the route from home to the station) are preferentially collected. Furthermore, the collection unit collaborates with geographic regional information (e.g., municipality, facility name) to preferentially collect utterances related to region-specific events or situations (e.g., festivals, traffic regulations, disasters). Examples of AI input include location information vectors (e.g., latitude 35.6895, longitude 139.6917, altitude 10 m), utterance text (e.g., “I'm going to the hospital today,” “I want to shop at the supermarket”). AI output includes relevance scores (e.g., 0.85), priority labels (e.g., high, medium, low), and collection flags (e.g., 1 or 0). These output values are used in subsequent processing by the collection unit, such as data transfer to the recording unit or selection of input data for the analysis unit. As a technical effect, the collection unit quantitatively evaluates the relevance between geographic location information and utterance content in a high-dimensional vector space, achieving high-precision information collection tailored to the person's current situation compared to conventional indiscriminate collection methods. This suppresses unnecessary data accumulation and enables efficient analysis and estimation processing, improving overall system responsiveness. Application fields include monitoring of dementia patients when going out, situation awareness in medical and care facilities, dialogue optimization for life support robots, and regionally coordinated health management systems. Furthermore, by changing the location information acquisition interval or relevance calculation algorithm, the system has extensibility to flexibly respond to diverse use cases such as urban, suburban, and indoor/outdoor environments.

The collection unit is configured to analyze the person's social media activity at the time of utterance collection and collect related utterances. For example, the collection unit can collect utterances related to topics the person frequently posts about on social media. The collection unit can also set collection timing based on the person's social media activity time periods. Furthermore, the collection unit can analyze the content of the person's social media posts and preferentially collect important utterances. By analyzing social media activity, related utterances can be collected. Specifically, the collection unit periodically obtains posting history data (e.g., posting time, posting content, number of reactions) via API from multiple social media platforms used by the person (e.g., microblogs, SNS, bulletin boards). The collection unit vectorizes posting content using natural language embedding models such as BERT or RoBERTa, and calculates the cosine similarity between topic vectors of the person's utterances and social media posts to obtain a relevance score. The collection unit clusters topics frequently posted by the person (e.g., health, hobbies, family, news), and preferentially collects and records utterances that show high relevance to these topics. For activity time period analysis, the system creates a histogram of posting times for the past month, automatically extracts peak time periods (e.g., 8:00-10:00 p.m.), and reflects this in utterance collection scheduling. For important utterance determination, the system uses importance estimation with TF-IDF scores or BERT embedding vectors, and preferentially collects utterances similar to social media posts with high engagement (e.g., number of likes, comments). Examples of AI input include social media post text (e.g., “I started a new hobby today,” “I've not been feeling well lately”), posting time (e.g., 2024-06-01 20:15), and utterance text (e.g., “I want to try a new hobby”). AI output includes relevance scores (e.g., 0.92), priority labels (e.g., high, medium, low), and recommended collection timing (e.g., 20:00-22:00). These output values are used in subsequent processing by the collection unit, such as data transfer to the recording unit, selection of input data for the analysis unit, and parameter setting for the collection scheduler. As a technical effect, the collection unit quantitatively evaluates the relevance between the person's social media activity and utterance content in a high-dimensional vector space, achieving high-precision information collection tailored to the person's interests, concerns, and social activity compared to conventional collection methods based only on utterance content. This enables early detection of changes in the person's social connections and psychological state, improving the quality of care and medical support and enabling personalized health management. Application fields include prevention of social isolation in dementia patients, monitoring of patients with mental disorders, home care support, and personalized health management applications. Furthermore, by changing the type of social media API or relevance calculation algorithm, the system has extensibility to flexibly respond to diverse platforms and use cases.

The analysis unit is configured to estimate the person's emotion and determine a method of expressing the analysis based on the estimated emotion. For example, if the person is relaxed, the analysis unit can provide detailed analysis results. If the person is feeling stressed, the analysis unit can provide concise analysis results. Furthermore, if the person is excited, the analysis unit can provide visually easy-to-understand analysis results. By adjusting the method of expressing the analysis according to the person's emotion, appropriate analysis results can be provided. Emotion estimation is realized using an emotion engine or generative AI, such as a text generation AI (e.g., LLM) or multimodal generative AI, but is not limited to these examples. Specifically, the analysis unit acquires the person's spoken voice and text data in real time and inputs them into an emotion estimation module. The emotion estimation module uses a BERT-based emotion classification model or a multimodal emotion estimation model, with utterance text (e.g., “I'm having fun today,” “I'm already tired”) and audio features (e.g., F0, energy, spectral envelope) as input, and generates emotion labels (e.g., relaxed, stressed, excited) and emotion intensity scores (e.g., relaxed 0.8, stressed 0.2) as output. The analysis unit dynamically switches the method of expressing analysis results based on emotion labels and intensity scores. When relaxed, the system generates a detailed report including detailed semantic analysis of utterance content (e.g., topic extraction, intention estimation, emotion transition graphs). When stressed, the system presents a concise summary extracting only key points (e.g., topic label, emotion label, important utterance list). When excited, the system outputs analysis results in a visually emphasized interface (e.g., color-coded graphs, icon display, emotion change animation). Examples of AI input include utterance text (e.g., “I'm feeling good today,” “I want help”), audio feature vectors (e.g., F0=120 Hz, energy=0.8), and emotion intensity scores (e.g., 0.7, 0.2, 0.1). AI output includes analysis expression type (e.g., detailed, concise, visual) and analysis result data (e.g., topic category, emotion transition graph, summary text). These output values are used in subsequent processing by the analysis unit, such as selection of display format for the user interface or data transfer to the recording unit. As a technical effect, the analysis unit optimizes the method of expressing analysis results according to the person's emotional state, enabling information provision that is easier to understand and tailored to the situation for the person and caregivers, compared to conventional uniform output methods. This enables efficient information transmission, stress reduction, and prompt decision-making support. Application fields include monitoring of dementia patients, monitoring of patients with mental disorders, home care support, and patient status reporting in medical settings. Furthermore, by changing the analysis expression algorithm or interface design, the system can flexibly respond to diverse use cases and individual optimization.

The analysis unit is configured to adjust the level of detail of the analysis based on the importance of the utterance at the time of analysis. For example, the analysis unit can perform detailed analysis for important utterances. The analysis unit can also perform concise analysis for daily utterances. Furthermore, the analysis unit can perform detailed analysis of emotional changes for emotional utterances. By adjusting the level of detail of the analysis based on the importance of the utterance, appropriate analysis results can be provided. Specifically, the analysis unit vectorizes utterance content using natural language embedding models such as BERT, calculates importance scores using TF-IDF scores or important word extraction algorithms, and performs multi-stage detailed analysis such as topic extraction, intention estimation, emotion transition analysis, and related event detection for utterances with high importance scores (e.g., “Help,” “I want to go outside”). The analysis results are output as structured data (e.g., topic category, intention label, emotion change graph). For daily utterances (e.g., “The weather is nice today”), only concise summaries such as topic labels and emotion labels are generated. For emotional utterances (e.g., “I can't take it anymore,” “Help”), the system performs detailed analysis of time-series changes in emotion intensity scores and anomaly detection, and outputs emotion change graphs and anomaly detection flags. Examples of AI input include utterance text (e.g., “Help,” “The weather is nice today”), importance scores (e.g., 0.95, 0.2), and emotion intensity scores (e.g., 0.8, 0.1, 0.1). AI output includes analysis detail level labels (e.g., detailed, concise) and analysis result data (e.g., topic category, emotion transition graph, summary text). These output values are used in subsequent processing by the analysis unit, such as display on the user interface or data transfer to the recording unit. As a technical effect, the analysis unit dynamically optimizes the level of detail of the analysis according to the importance of the utterance, greatly improving information coverage and system responsiveness compared to conventional uniform analysis methods. This enables caregivers and medical professionals to receive information that allows for prompt and accurate response. Application fields include monitoring of dementia patients, monitoring of patients with mental disorders, home care support, and grasping patient status in medical settings. Furthermore, by changing the importance calculation algorithm or threshold settings for analysis detail level, the system can flexibly respond to diverse use cases and individual optimization.

The analysis unit is configured to apply different analysis algorithms according to the category of the utterance at the time of analysis. For example, the analysis unit can apply emotion analysis algorithms to emotional utterances. The analysis unit can also apply natural language processing algorithms to daily utterances. Furthermore, the analysis unit can apply detailed semantic analysis algorithms to important utterances. By applying different analysis algorithms according to the category of the utterance, appropriate analysis results can be provided. Specifically, the analysis unit inputs utterance content into a pre-trained category classification model (e.g., multi-class classifier, BERT-based utterance category classification model) to determine the utterance category (e.g., emotional, daily, important). For emotional utterances (e.g., “I can't take it anymore,” “Help”), the system applies BERT-based emotion classification models or multimodal emotion estimation models to analyze emotion labels and emotion intensity scores in detail. For daily utterances (e.g., “The weather is nice today”), the system applies natural language processing algorithms such as morphological analysis, named entity extraction, and dependency structure analysis to generate topic labels and summary text. For important utterances (e.g., “I want to go outside,” “I don't know where I am”), the system applies semantic analysis algorithms (e.g., semantic similarity calculation using BERT embedding vectors, intention estimation models) to output detailed analysis results such as topic category, intention label, and related event detection. Examples of AI input include utterance text (e.g., “Help,” “The weather is nice today,” “I want to go outside”), category labels (e.g., emotional, daily, important). AI output includes analysis algorithm selection labels (e.g., emotion analysis, natural language processing, semantic analysis) and analysis result data (e.g., emotion intensity score, topic category, intention label). These output values are used in subsequent processing by the analysis unit, such as display on the user interface or data transfer to the recording unit. As a technical effect, the analysis unit dynamically selects and applies the optimal analysis algorithm for each utterance category, greatly improving analysis accuracy and information coverage compared to conventional uniform analysis methods. This enables caregivers and medical professionals to promptly take appropriate action according to the situation. Application fields include monitoring of dementia patients, monitoring of patients with mental disorders, home care support, and grasping patient status in medical settings. Furthermore, by changing the category classification model or type of analysis algorithm, the system can flexibly respond to diverse use cases and individual optimization.

The analysis unit is configured to estimate the person's emotion and determine the length of the analysis based on the estimated emotion. For example, if the person is relaxed, the analysis unit can perform detailed analysis. If the person is feeling stressed, the analysis unit can perform concise analysis. Furthermore, if the person is excited, the analysis unit can perform visually easy-to-understand analysis. By adjusting the length of the analysis according to the person's emotion, appropriate analysis results can be provided. Emotion estimation is realized using an emotion engine or generative AI, such as a text generation AI (e.g., LLM) or multimodal generative AI, but is not limited to these examples. Specifically, the analysis unit acquires the person's spoken voice data and text data in real time and inputs them into an emotion estimation module. The emotion estimation module uses a BERT-based emotion classification model or a multimodal emotion estimation model that takes both audio and text as input. Examples of AI input include utterance text (e.g., “I'm feeling good today,” “I want help”), audio feature vectors (e.g., F0=120 Hz, energy=0.8, spectral envelope=0.6), gesture data (e.g., acceleration values 0.2, 0.1, 0.3). The emotion estimation model outputs emotion labels (e.g., relaxed, stressed, excited) and emotion intensity scores (e.g., relaxed 0.8, stressed 0.1, excited 0.1). The analysis unit dynamically determines the analysis length parameter (e.g., detailed, concise, visual) based on emotion labels and intensity scores. When relaxed, the system generates a long report including detailed semantic analysis of utterance content (e.g., topic extraction, intention estimation, emotion transition graph generation, related event detection). When stressed, the system generates a short summary extracting only key points (e.g., topic label, emotion label, important utterance list). When excited, the system outputs analysis results in a visually emphasized interface (e.g., color-coded graphs, icon display, emotion change animation). Examples of AI output include analysis length labels (e.g., detailed, concise, visual) and analysis result data (e.g., topic category, emotion transition graph, summary text). These output values are used in subsequent processing by the analysis unit, such as selection of display format for the user interface or data transfer to the recording unit. As a technical effect, the analysis unit optimizes the length and method of expressing analysis results according to the person's emotional state, enabling information provision that is easier to understand and tailored to the situation for the person and caregivers, compared to conventional uniform output methods. This enables efficient information transmission, stress reduction, and prompt decision-making support. Application fields include monitoring of dementia patients, monitoring of patients with mental disorders, home care support, and patient status reporting in medical settings. Furthermore, by changing the analysis length control algorithm or interface design, the system can flexibly respond to diverse use cases and individual optimization. The analysis unit can realize optimal analysis length control according to individual characteristics and site requirements by changing the type and parameters (e.g., thresholds, weighting) of the emotion estimation model, greatly improving the flexibility and extensibility of computer technology.

The analysis unit is configured to determine the priority of the analysis based on the submission timing of the utterance at the time of analysis. For example, the analysis unit can preferentially analyze recent utterances. The analysis unit can also preferentially analyze important past utterances. Furthermore, the analysis unit can preferentially analyze utterances related to specific events. By determining the priority of the analysis based on the submission timing of the utterance, appropriate analysis results can be provided. Specifically, the analysis unit obtains metadata such as timestamps (e.g., 2024-06-01 10:15:00), utterance content, importance scores, and event tags for each utterance from the utterance database. The analysis unit uses time-series sorting algorithms or priority queues to schedule preferential analysis of the latest utterances and event-related utterances. Examples of AI input include utterance text (e.g., “Help,” “The weather is nice today”), submission time (e.g., 2024-06-01 10:15:00), and event tags (e.g., medical visit, going out, meal). AI outputs analysis priority scores (e.g., 0.95, 0.2) and analysis order labels (e.g., high, medium, low) based on submission timing and event tags. The analysis unit performs multi-stage analysis such as detailed semantic analysis, emotion estimation, and topic extraction in order of utterances with high priority scores. For important past utterances, the system combines importance estimation using TF-IDF or BERT embedding vectors and preferentially re-analyzes those with high importance. For utterances related to specific events, the system calculates the proximity between event occurrence time and utterance time and the relevance of content, and dynamically adjusts priority. These output values are used in subsequent processing by the analysis unit, such as display order on the user interface or data transfer order to the recording unit. As a technical effect, the analysis unit dynamically controls priority based on submission timing and event relevance, greatly improving rapid extraction of important information and situational responsiveness compared to conventional simple time-series analysis methods. This enables caregivers and medical professionals to access necessary information in real time and respond promptly. Application fields include monitoring of dementia patients, grasping patient status in medical settings, home care support, and emergency response systems. Furthermore, by changing the analysis priority algorithm or event tag assignment method, the system can flexibly respond to diverse use cases and individual optimization. The analysis unit can adjust weighting and threshold settings for priority scores according to site requirements and individual characteristics, greatly improving the flexibility and extensibility of computer technology.

The analysis unit is configured to adjust the order of the analysis based on the relevance of the utterance at the time of analysis. For example, the analysis unit can preferentially analyze highly relevant utterances. The analysis unit can also postpone the analysis of less relevant utterances. Furthermore, the analysis unit can optimize the order of analysis based on the relevance of utterances. By adjusting the order of analysis based on the relevance of utterances, appropriate analysis results can be provided. Specifically, the analysis unit vectorizes utterance content using natural language embedding models such as BERT or RoBERTa, calculates relevance scores between utterances using cosine similarity or clustering methods (e.g., K-means, hierarchical clustering). Examples of AI input include utterance text (e.g., “I want to go outside,” “I don't know where I am,” “The weather is nice today”), utterance vectors (e.g., 768-dimensional BERT embeddings). AI outputs relevance score matrices (e.g., between utterance A and B: 0.92, between A and C: 0.15), related cluster labels (e.g., going out related, daily conversation, health related). The analysis unit preferentially groups and analyzes utterances with high relevance scores, and schedules less relevant utterances for later analysis. Furthermore, the system applies order optimization algorithms based on relevance (e.g., graph-based priority determination, dynamic programming) to balance analysis efficiency and information coverage. These output values are used in subsequent processing by the analysis unit, such as display order on the user interface or data transfer order to the recording unit. As a technical effect, the analysis unit quantitatively evaluates the content relevance of utterances in a high-dimensional vector space, greatly improving the accuracy of information grouping and situational awareness compared to conventional simple time-series analysis methods. This enables caregivers and medical professionals to grasp related information collectively and respond promptly and accurately. Application fields include monitoring of dementia patients, grasping patient status in medical settings, home care support, and dialogue optimization for life support robots. Furthermore, by changing the relevance calculation algorithm or clustering method, the system can flexibly respond to diverse use cases and individual optimization. The analysis unit can adjust thresholds for relevance scores and the number of clusters according to site requirements and individual characteristics, greatly improving the flexibility and extensibility of computer technology.

The estimation unit is configured to estimate the person's emotion and determine a method for estimating the intention based on the estimated emotion. For example, if the person is relaxed, the estimation unit can estimate detailed intentions. If the person is feeling stressed, the estimation unit can estimate concise intentions. Furthermore, if the person is excited, the estimation unit can estimate intentions by considering changes in emotion. By adjusting the method for estimating the intention according to the person's emotion, appropriate intentions can be estimated. Emotion estimation is realized using an emotion engine or generative AI, such as a text generation AI (e.g., LLM) or multimodal generative AI, but is not limited to these examples. Specifically, the estimation unit inputs features such as utterance content, emotion labels, and emotion intensity scores received from the analysis unit into estimation algorithms (e.g., multilayer perceptron, decision tree, rule-based estimator) to estimate intentions. Examples of AI input include utterance text (e.g., “I want to go outside,” “Help”), emotion labels (e.g., relaxed, stressed, excited), emotion intensity scores (e.g., 0.8, 0.1, 0.1), utterance time, and related event tags. When relaxed, the estimation unit comprehensively analyzes utterance content, past behavior history, and living conditions data to estimate detailed intentions (e.g., desire to go out, desire for hobby activities). When stressed, the estimation unit extracts only key points to estimate concise intentions (e.g., request for rest, seeking help). When excited, the estimation unit considers changes and anomalies in emotion intensity to estimate urgent intentions (e.g., seeking help, signs of abnormal behavior). Examples of AI output include intention labels (e.g., desire to go out, request for rest, seeking help), estimation confidence scores (e.g., 0.92), and estimation detail level labels (e.g., detailed, concise, urgent). These output values are used in subsequent processing by the estimation unit, such as alert transmission to notification systems or caregiver terminals, and data transfer to the recording unit. As a technical effect, the estimation unit dynamically optimizes the method for estimating intentions according to the person's emotional state, achieving high-precision intention grasping and prompt response tailored to the situation compared to conventional uniform estimation methods. This enables caregivers and medical professionals to promptly respond to changes in the person's state, improving the quality of support and ensuring safety. Application fields include monitoring of dementia patients, monitoring of patients with mental disorders, home care support, and grasping patient intentions in medical settings. Furthermore, by changing the estimation algorithm or type and parameters of the emotion estimation model, the system can flexibly respond to diverse use cases and individual optimization. The estimation unit can adjust the logic for switching estimation methods and confidence thresholds according to site requirements and individual characteristics, greatly improving the flexibility and extensibility of computer technology.

The estimation unit is configured to optimize the estimation algorithm by referring to past utterance data at the time of estimation. For example, the estimation unit can adjust the estimation algorithm based on past utterance data. The estimation unit can also improve the accuracy of intention estimation by referring to past utterance content. Furthermore, the estimation unit can optimize the estimation algorithm by analyzing past utterance patterns. By referring to past utterance data, the estimation algorithm can be optimized and estimation accuracy can be improved. Specifically, the estimation unit maintains a time-series database of the person's utterance history for the past week to month (e.g., utterance time, utterance content, emotion score, utterance length, estimated intention label), and uses time-series clustering, autoregressive models (AR models), or LSTM time-series neural networks to automatically extract peak time periods of utterance frequency and utterance patterns. Examples of AI input include past utterance text sequences (e.g., “Help,” “I want to go outside,” “The weather is nice today”), utterance time series (e.g., 2024-06-01 10:15, 2024-06-01 12:30, . . . ), and emotion score series (e.g., 0.8, 0.2, 0.1, . . . ). The estimation unit dynamically optimizes estimation algorithm parameters (e.g., weights, thresholds, feature selection) based on extracted patterns and features. For example, during time periods when utterances such as “Help” or “I want to go outside” frequently occur, the system increases the estimation weight for desire to go out or request for help. The system also considers importance scores of utterance content and patterns of emotion score fluctuations, and automatically switches the estimation algorithm when abnormal patterns occur. Examples of AI output include optimized estimation algorithm parameters, estimation confidence scores (e.g., 0.95), and estimated intention labels (e.g., desire to go out, seeking help). These output values are used in subsequent processing by the estimation unit, such as alert transmission to notification systems or data transfer to the recording unit. As a technical effect, the estimation unit analyzes past utterance history with AI models and dynamically optimizes the estimation algorithm, greatly improving information coverage and estimation accuracy compared to conventional fixed parameter methods. This enables high-precision intention estimation tailored to changes in the person's state and individual characteristics. Application fields include monitoring of dementia patients, monitoring of patients with mental disorders, home care support, and grasping patient status in medical settings. Furthermore, by changing the analysis algorithm or parameter optimization method, the system can flexibly respond to diverse use cases and individual optimization. The estimation unit can adjust optimization logic and feature selection criteria according to site requirements and individual characteristics, greatly improving the flexibility and extensibility of computer technology.

The estimation unit is configured to apply different estimation methods according to the category of the utterance at the time of estimation. For example, the estimation unit can estimate intentions based on emotion analysis for emotional utterances. The estimation unit can also estimate intentions based on natural language processing for daily utterances. Furthermore, the estimation unit can estimate intentions based on detailed semantic analysis for important utterances. By applying different estimation methods according to the category of the utterance, appropriate intentions can be estimated. Specifically, the estimation unit inputs utterance content received from the analysis unit into a pre-trained category classification model (e.g., multi-class classifier, BERT-based utterance category classification model) to determine the utterance category (e.g., emotional, daily, important). For emotional utterances (e.g., “I can't take it anymore,” “Help”), the system applies BERT-based emotion classification models or multimodal emotion estimation models to analyze emotion labels and emotion intensity scores in detail, and inputs these emotion features into estimation algorithms such as multilayer perceptrons or decision trees to estimate the person's intention (e.g., seeking help, requesting rest). For daily utterances (e.g., “The weather is nice today”), the system applies natural language processing algorithms such as morphological analysis, named entity extraction, and dependency structure analysis to extract topic labels and summary text, and then estimates daily intentions (e.g., desire to continue conversation, desire for casual talk). For important utterances (e.g., “I want to go outside,” “I don't know where I am”), the system applies semantic similarity calculation using BERT embedding vectors or intention estimation models, and estimates intentions considering urgency and importance based on detailed analysis results such as topic category, intention label, and related event detection (e.g., desire to go out, request for emergency support). Examples of AI input include utterance text (e.g., “Help,” “The weather is nice today,” “I want to go outside”), category labels (e.g., emotional, daily, important), audio features (e.g., F0, energy, spectral envelope), and emotion intensity scores (e.g., 0.8, 0.1, 0.1). AI output includes intention labels (e.g., desire to go out, request for rest, seeking help), estimation confidence scores (e.g., 0.92), and estimation detail level labels (e.g., detailed, concise, urgent). These output values are used in subsequent processing by the estimation unit, such as alert transmission to notification systems or caregiver terminals, and data transfer to the recording unit. As a technical effect, the estimation unit dynamically selects and applies the optimal estimation algorithm for each utterance category, greatly improving analysis accuracy and information coverage compared to conventional uniform estimation methods. This enables caregivers and medical professionals to promptly take appropriate action according to the situation. Application fields include monitoring of dementia patients, monitoring of patients with mental disorders, home care support, and grasping patient status in medical settings. Furthermore, by changing the category classification model or type of estimation algorithm, the system can flexibly respond to diverse use cases and individual optimization. The estimation unit can adjust the logic for switching estimation methods and confidence thresholds according to site requirements and individual characteristics, greatly improving the flexibility and extensibility of computer technology.

The estimation unit can estimate the person's emotion and determine the priority of estimation based on the estimated emotion. For example, when the person is relaxed, the estimation unit can preferentially estimate detailed intentions. When the person is feeling stressed, the estimation unit can preferentially estimate concise intentions. Furthermore, when the person is excited, the estimation unit can preferentially estimate intentions by considering changes in emotion. By determining the estimation priority according to the person's emotion, appropriate intentions can be estimated. Emotion estimation is realized, for example, by using an emotion engine or an emotion estimation function utilizing generative AI. Generative AI may include text generation AI (e.g., LLM) or multimodal generative AI, but is not limited to these examples. Specifically, the estimation unit receives features such as utterance content, emotion labels, and emotion intensity scores from the analysis unit, and performs intention estimation using estimation algorithms (e.g., multilayer perceptron, decision tree, rule-based estimator). Examples of input to the AI include utterance text (e.g., “I want to go outside”, “Help me”), emotion labels (e.g., relaxed, stressed, excited), emotion intensity scores (e.g., 0.8, 0.1, 0.1), utterance time, and related event tags. When the person is relaxed, the estimation unit comprehensively analyzes utterance content, past behavioral history, living condition data, etc., and preferentially estimates detailed intentions (e.g., desire to go out, desire for hobby activities). When the person is stressed, the estimation unit preferentially estimates concise intentions that extract only the main points (e.g., request for a break, seeking help). When the person is excited, the estimation unit considers changes in emotion intensity and outliers, and preferentially estimates urgent intentions (e.g., seeking help, signs of abnormal behavior). Examples of AI output include intention labels (e.g., desire to go out, request for a break, seeking help), estimation confidence scores (e.g., 0.92), and estimation priority labels (e.g., high, medium, low). These output values are used in subsequent processing by the estimation unit, such as alert transmission to notification systems or caregiver terminals, and data transfer to the recording unit. As a technical effect, the estimation unit dynamically optimizes estimation priority according to the person's emotional state, thereby achieving higher accuracy in intention recognition and faster response than conventional uniform estimation methods. This enables caregivers and medical professionals to respond promptly to changes in the person's condition, improving the quality of support and ensuring safety. Application fields include monitoring of dementia patients, monitoring of psychiatric patients, home care support, and intention recognition in medical settings. Furthermore, by changing the types and parameters of estimation algorithms and emotion estimation models, the system can flexibly accommodate various use cases and individual optimization. The estimation unit can adjust estimation priority determination logic and confidence thresholds according to field requirements and individual characteristics, greatly enhancing the flexibility and scalability of computer technology.

The estimation unit can perform weighting of estimation based on the submission timing of utterances at the time of estimation. For example, the estimation unit can estimate intentions by placing emphasis on recent utterances. The estimation unit can also estimate intentions by emphasizing important past utterances. Furthermore, the estimation unit can estimate intentions by emphasizing utterances related to specific events. By performing weighting of estimation based on the submission timing of utterances, appropriate intentions can be estimated. Specifically, the estimation unit obtains metadata such as timestamps for each utterance (e.g., 2024-06-01 10:15:00), utterance content, importance scores, and event tags from the utterance database, and uses time-series sorting algorithms or priority queues to weight recent utterances and event-related utterances as input to the estimation algorithm. Examples of input to the AI include utterance text (e.g., “Help me”, “The weather is nice today”), submission time (e.g., 2024-06-01 10:15:00), event tags (e.g., hospital visit, outing, meal), and importance scores (e.g., 0.95, 0.2). The AI outputs estimation weight scores (e.g., 0.9, 0.3) and estimation priority labels (e.g., high, medium, low) based on submission timing and event tags. The estimation unit performs multi-stage estimation such as detailed semantic analysis, emotion estimation, and topic extraction in order from utterances with high weighting scores. For important past utterances, importance estimation using TF-IDF or BERT embedding vectors is combined, and those with high importance are preferentially re-estimated. For utterances related to specific events, the proximity of event occurrence time and utterance time and the relevance of content are calculated, and weighting is dynamically adjusted. These output values are used in subsequent processing by the estimation unit, such as determining the order of data transfer to notification systems or the recording unit. As a technical effect, the estimation unit greatly improves the speed of extracting important information and situational responsiveness compared to conventional simple time-series estimation methods by dynamically controlling weighting based on submission timing and event relevance. This enables caregivers and medical professionals to access necessary information in real time, allowing for rapid decision-making and response. Application fields include monitoring of dementia patients, patient status recognition in medical settings, home care support, and emergency response systems. Furthermore, by changing the weighting algorithms and event tag assignment methods, the system can flexibly accommodate various use cases and individual optimization. The estimation unit can adjust the weighting and threshold settings of weighting scores according to field requirements and individual characteristics, greatly enhancing the flexibility and scalability of computer technology.

The estimation unit can refer to relevant market data at the time of estimation. For example, the estimation unit can estimate intentions based on relevant market data. The estimation unit can also estimate intentions by considering market trends. Furthermore, the estimation unit can improve the accuracy of intention estimation by referring to market data. By referring to relevant market data, the accuracy of intention estimation can be improved. Specifically, the estimation unit periodically acquires the latest market prices, demand trends, and trend indicators (e.g., stock prices, consumer indices, search trends) from external market databases or open data APIs, and links these with input features for utterance content and intention estimation. Examples of input to the AI include utterance text (e.g., “I want new home appliances”, “I want to eat out”), market price data (e.g., average price in the home appliance category, eating out cost index), and trend scores (e.g., home appliance demand 1.2x, eating out trend 0.8). The estimation unit quantifies the relevance between utterance content and market data using BERT embedding vectors or cosine similarity calculations, and when the relevance score is high, performs intention estimation that takes market trends into account (e.g., intention to purchase home appliances, desire to eat out). Examples of AI output include intention labels (e.g., desire to purchase home appliances, desire to eat out), estimation confidence scores (e.g., 0.88), and market linkage scores (e.g., 0.75). These output values are used in subsequent processing by the estimation unit, such as data transfer to notification systems or the recording unit, and linkage to recommendation systems. As a technical effect, the estimation unit quantitatively evaluates the relevance between external market data and utterance content in a high-dimensional vector space, thereby achieving higher accuracy in intention estimation that reflects social and economic conditions compared to conventional estimation methods based only on utterance content. This enables early recognition of changes in the person's consumption behavior and life intentions, and improves the quality of personalized support and recommendations. Application fields include consumer behavior analysis, personalized recommendations, life support robots, and health management applications. Furthermore, by changing the types of market data APIs and relevance calculation algorithms, the system can flexibly accommodate various industries and use cases. The estimation unit can adjust market data linkage logic and weighting parameters according to field requirements and individual characteristics, greatly enhancing the flexibility and scalability of computer technology.

The recording unit can estimate the person's emotion and adjust the method of recording lifelogs based on the estimated emotion. For example, when the person is relaxed, the recording unit can record detailed lifelogs. When the person is feeling stressed, the recording unit can record concise lifelogs. Furthermore, when the person is excited, the recording unit can record lifelogs by considering changes in emotion. By adjusting the method of recording lifelogs according to the person's emotion, appropriate lifelogs can be recorded. Emotion estimation is realized, for example, by using an emotion engine or an emotion estimation function utilizing generative AI. Generative AI may include text generation AI (e.g., LLM) or multimodal generative AI, but is not limited to these examples. Specifically, the recording unit acquires the person's utterance audio data, text data, vital sensor data (e.g., heart rate, blood pressure, body temperature), accelerometer data, and GPS location information in real time, and inputs these to the emotion estimation module. The emotion estimation module uses a BERT-based emotion classification model or a multimodal emotion estimation model that integrates audio, text, and biometric information. Examples of input to the AI include utterance text (e.g., “I'm feeling good today”, “I'm already tired”), audio features (e.g., F0=120 Hz, energy=0.8), vital data (e.g., heart rate 80 bpm, blood pressure 120/80), and acceleration values (e.g., 0.2, 0.1, 0.3). The AI outputs emotion labels (e.g., relaxed, stressed, excited) and emotion intensity scores (e.g., relaxed 0.8, stressed 0.1, excited 0.1) from these inputs. The recording unit dynamically determines lifelog recording method parameters (e.g., recording granularity, number of recording items, recording format) based on emotion labels and intensity scores. When the person is relaxed, detailed lifelogs such as activity history (steps, distance traveled, calories burned), health data (heart rate, blood pressure, body temperature), utterance content, and emotion transition graphs are recorded at one-minute intervals. When the person is stressed, concise lifelogs that extract only major events (e.g., start of movement, occurrence of utterance, vital abnormality) and key points (e.g., event timestamp, emotion label, main utterance) are recorded at five-minute intervals. When the person is excited, changes in emotion intensity and outliers are recorded with emphasis, and lifelogs with emotion change graphs and abnormality detection flags are generated. Examples of AI output include recording method labels (e.g., detailed, concise, abnormality emphasis), recording item lists (e.g., activity history, emotion transition, abnormal events), and recording frequency (e.g., 1 minute, 5 minutes, upon event occurrence). These output values are used in subsequent processing by the recording unit, such as storage in a time-series database, backup to a cloud server, and data transfer to family or medical professional terminals. As a technical effect, the recording unit dynamically optimizes the lifelog recording method according to the person's emotional state, greatly improving the comprehensiveness, importance, and responsiveness of information compared to conventional uniform recording methods. This enables early detection of abnormal behavior and changes in health status, and optimization of care plans and medical responses. Application fields include monitoring of dementia patients, monitoring of psychiatric patients, home care support, health management applications, and medical data linkage platforms. Furthermore, by changing the types and parameters of emotion estimation models and recording method control algorithms, the system can flexibly accommodate various use cases and individual optimization. The recording unit can adjust recording method switching logic and criteria for recording granularity and item selection according to field requirements and individual characteristics, greatly enhancing the flexibility and scalability of computer technology.

The recording unit can optimize the recording algorithm by referring to past lifelog data at the time of recording. For example, the recording unit can adjust the recording algorithm based on past lifelog data. The recording unit can also improve recording accuracy by referring to past lifelog content. Furthermore, the recording unit can analyze past lifelog patterns and optimize the recording algorithm. By referring to past lifelog data, the recording algorithm can be optimized and recording accuracy can be improved. Specifically, the recording unit maintains a time-series database of the person's lifelog data for the past week to month (e.g., activity history, health data, utterance content, emotion scores, recording frequency, recording granularity), and uses time-series clustering, autoregressive models (AR models), or LSTM and other time-series neural networks to automatically extract recording patterns and abnormality occurrence trends. Examples of input to the AI include past lifelog data series (e.g., steps, heart rate, number of utterances, emotion scores), recording time series (e.g., 2024-06-01 10:15, 2024-06-01 12:30, . . . ), and recording granularity (e.g., 1 minute, 5 minutes, upon event occurrence). The recording unit dynamically optimizes parameters of the recording algorithm (e.g., recording frequency, selection of recording items, abnormality detection thresholds) based on extracted patterns and features. For example, if abnormal values (e.g., sudden increase in heart rate, wandering at midnight) frequently occur during certain time periods, the recording frequency and number of recording items are increased during those periods. Conversely, if stable patterns continue, the recording granularity is coarsened to reduce storage consumption and communication load. Examples of AI output include optimized recording algorithm parameters, recording accuracy scores (e.g., 0.95), and recording item lists (e.g., activity history, emotion transition, abnormal events). These output values are used in subsequent processing by the recording unit, such as storage in a time-series database, backup to a cloud server, and data transfer to family or medical professional terminals. As a technical effect, the recording unit analyzes past lifelog history with AI models and dynamically optimizes the recording algorithm, greatly improving the comprehensiveness and accuracy of information compared to conventional fixed-parameter methods. This enables high-precision lifelog recording that responds to changes in the person's condition and individual characteristics. Application fields include monitoring of dementia patients, monitoring of psychiatric patients, home care support, patient status recognition in medical settings, and health management applications. Furthermore, by changing analysis algorithms and parameter optimization methods, the system can flexibly accommodate various use cases and individual optimization. The recording unit can adjust optimization logic and criteria for feature selection according to field requirements and individual characteristics, greatly enhancing the flexibility and scalability of computer technology.

The recording unit can estimate the person's emotion and adjust the frequency of recording based on the estimated emotion. For example, when the person is relaxed, the recording unit can record lifelogs frequently. When the person is feeling stressed, the recording unit can reduce the recording frequency. Furthermore, when the person is excited, the recording unit can adjust the recording frequency to avoid missing important events. By adjusting the recording frequency according to the person's emotion, appropriate lifelogs can be recorded. Emotion estimation is realized, for example, by using an emotion engine or an emotion estimation function utilizing generative AI. Generative AI may include text generation AI (e.g., LLM) or multimodal generative AI, but is not limited to these examples. Specifically, the recording unit acquires the person's utterance audio data, text data, vital sensor data, accelerometer data, and GPS location information in real time, and inputs these to the emotion estimation module. The emotion estimation module uses a BERT-based emotion classification model or a multimodal emotion estimation model that integrates audio, text, and biometric information. Examples of input to the AI include utterance text (e.g., “I'm feeling good today”, “I'm already tired”), audio features (e.g., F0=120 Hz, energy=0.8), vital data (e.g., heart rate 80 bpm, blood pressure 120/80), and acceleration values (e.g., 0.2, 0.1, 0.3). The AI outputs emotion labels (e.g., relaxed, stressed, excited) and emotion intensity scores (e.g., relaxed 0.8, stressed 0.1, excited 0.1) from these inputs. The recording unit dynamically sets recording frequency parameters (e.g., 1-minute intervals when relaxed, 5-minute intervals when stressed, 30-second intervals when excited) based on emotion labels and intensity scores. When the person is relaxed, lifelogs are recorded at high frequency with emphasis on natural life rhythms; when stressed, the recording frequency is lowered to avoid burden from excessive recording; when excited, lifelogs are recorded at short intervals to avoid missing important events or signs of abnormal behavior. Examples of AI output include recording frequency labels (e.g., high, medium, low), recording intervals (e.g., 1 minute, 5 minutes, 30 seconds), and recording permission flags (e.g., 1 or 0). These output values are used in subsequent processing by the recording unit, such as storage in a time-series database, backup to a cloud server, and data transfer to family or medical professional terminals. As a technical effect, the recording unit dynamically optimizes recording frequency according to the person's emotional state, greatly improving the comprehensiveness of information and system responsiveness compared to conventional fixed-interval recording methods. This enables early detection of abnormal behavior and changes in health status, and optimization of care plans and medical responses. Application fields include monitoring of dementia patients, monitoring of psychiatric patients, home care support, health management applications, and medical data linkage platforms. Furthermore, by changing the types and parameters of emotion estimation models and recording frequency control algorithms, the system can flexibly accommodate various use cases and individual optimization. The recording unit can adjust recording frequency switching logic and criteria for setting recording intervals according to field requirements and individual characteristics, greatly enhancing the flexibility and scalability of computer technology.

The recording unit can perform weighting of recording data based on the submission timing of lifelogs at the time of recording. For example, the recording unit can place emphasis on recent lifelogs when recording. The recording unit can also place emphasis on important past events when recording. Furthermore, the recording unit can place emphasis on lifelogs related to specific events when recording. By performing weighting of recording data based on the submission timing of lifelogs, appropriate lifelogs can be recorded. Specifically, the recording unit obtains metadata such as timestamps for each recording data (e.g., 2024-06-01 10:15:00), recording content, event tags (e.g., hospital visit, outing, meal), and importance scores from the lifelog database, and uses time-series sorting algorithms or priority queues to weight recent records and event-related records as input to the recording algorithm. Examples of input to the AI include lifelog content (e.g., steps, heart rate, utterance content), recording time (e.g., 2024-06-01 10:15:00), event tags (e.g., hospital visit, outing, meal), and importance scores (e.g., 0.95, 0.2). The AI outputs recording weight scores (e.g., 0.9, 0.3) and recording priority labels (e.g., high, medium, low) based on submission timing and event tags. The recording unit performs multi-stage recording processing such as detailed recording, backup, and data transfer in order from recording data with high weighting scores. For important past events, importance estimation using TF-IDF or BERT embedding vectors is combined, and those with high importance are preferentially re-recorded or re-backed up. For records related to specific events, the proximity of event occurrence time and recording time and the relevance of content are calculated, and weighting is dynamically adjusted. These output values are used in subsequent processing by the recording unit, such as storage in a time-series database, backup to a cloud server, and determining the order of data transfer to family or medical professional terminals. As a technical effect, the recording unit greatly improves the speed of extracting important information and situational responsiveness compared to conventional simple time-series recording methods by dynamically controlling weighting based on submission timing and event relevance. This enables caregivers and medical professionals to access necessary information in real time, allowing for rapid decision-making and response. Application fields include monitoring of dementia patients, patient status recognition in medical settings, home care support, and emergency response systems. Furthermore, by changing the weighting algorithms and event tag assignment methods, the system can flexibly accommodate various use cases and individual optimization. The recording unit can adjust the weighting and threshold settings of weighting scores according to field requirements and individual characteristics, greatly enhancing the flexibility and scalability of computer technology.

The prevention unit can estimate the person's emotion and adjust the method of wandering prevention based on the estimated emotion. For example, when the person is relaxed, the prevention unit can prevent wandering using gentle methods. When the person is feeling stressed, the prevention unit can prevent wandering using methods that reduce stress. Furthermore, when the person is excited, the prevention unit can prevent wandering using methods that calm the emotion. By adjusting the method of wandering prevention according to the person's emotion, appropriate wandering prevention can be achieved. Emotion estimation is realized, for example, by using an emotion engine or an emotion estimation function utilizing generative AI. Generative AI may include text generation AI (e.g., LLM) or multimodal generative AI, but is not limited to these examples. Specifically, the prevention unit acquires the person's utterance audio data, text data, vital sensor data, accelerometer data, and GPS location information in real time, and inputs these to the emotion estimation module. The emotion estimation module uses a BERT-based emotion classification model or a multimodal emotion estimation model that integrates audio, text, and biometric information. Examples of input to the AI include utterance text (e.g., “I'm feeling good today”, “I'm already tired”), audio features (e.g., F0=120 Hz, energy=0.8), vital data (e.g., heart rate 80 bpm, blood pressure 120/80), and acceleration values (e.g., 0.2, 0.1, 0.3). The AI outputs emotion labels (e.g., relaxed, stressed, excited) and emotion intensity scores (e.g., relaxed 0.8, stressed 0.1, excited 0.1) from these inputs. The prevention unit dynamically determines wandering prevention method parameters (e.g., alert intensity, notification method, behavior restriction level) based on emotion labels and intensity scores. When the person is relaxed, gentle alerts such as voice guidance or soft vibration are used to prevent wandering. When the person is stressed, notification frequency and alert intensity are lowered to avoid amplifying stress, and notification to family or caregivers is prioritized. When the person is excited, voice messages to calm emotion or relaxation-inducing audio are played, and emergency notification is performed as needed. Examples of AI output include prevention method labels (e.g., gentle, stress reduction, emotion stabilization), alert intensity (e.g., low, medium, high), and notification recipient lists (e.g., person, family, security company). These output values are used in subsequent processing by the prevention unit, such as alert transmission, execution of behavior restrictions, and data transfer to the recording unit. As a technical effect, the prevention unit dynamically optimizes wandering prevention methods according to the person's emotional state, thereby achieving high-precision wandering prevention while reducing psychological burden compared to conventional uniform alert methods. This enables safety assurance and QOL improvement for the person, and reduction of caregiver burden. Application fields include monitoring of dementia patients, monitoring of psychiatric patients, home care support, and wandering prevention in medical and care facilities. Furthermore, by changing the types and parameters of emotion estimation models and prevention method control algorithms, the system can flexibly accommodate various use cases and individual optimization. The prevention unit can adjust prevention method switching logic and criteria for setting alert intensity according to field requirements and individual characteristics, greatly enhancing the flexibility and scalability of computer technology.

The prevention unit can optimize the prevention algorithm by referring to past wandering data at the time of prevention. For example, the prevention unit can adjust the prevention algorithm based on past wandering data. The prevention unit can also analyze past wandering patterns and optimize the prevention algorithm. Furthermore, the prevention unit can refer to past wandering data to improve the accuracy of wandering prevention. By referring to past wandering data, the prevention algorithm can be optimized and the accuracy of wandering prevention can be improved. Specifically, the prevention unit maintains a time-series database of the person's wandering history for the past week to month (e.g., wandering occurrence time, occurrence location, movement route, emotion scores before and after wandering, alert transmission history, intervention results), and inputs these data to time-series clustering, autoregressive models (AR models), or LSTM and other time-series neural networks to automatically extract trends and patterns of wandering occurrence (e.g., nighttime outings, frequent wandering on specific days, tendency to deviate from specific routes). The prevention unit dynamically optimizes parameters of the prevention algorithm (e.g., alert thresholds, notification timing, behavior restriction level, alert intensity) based on extracted patterns and features. For example, if nighttime wandering is frequent, the alert threshold is lowered and alert transmission frequency is increased during nighttime. If deviation is frequent on specific movement routes, alert intensity is increased only when passing those routes. Furthermore, the prevention unit analyzes the correlation between emotion scores and vital data (e.g., increased heart rate, increased stress score) before and after wandering, and optimizes preventive alert transmission and intervention timing during emotional abnormalities. Examples of input to the AI include wandering occurrence time series (e.g., 2024-06-01 02:15, 2024-06-03 23:40, . . . ), movement route vectors (e.g., GPS coordinate sequences), emotion score series (e.g., 0.8, 0.2, 0.1, . . . ), alert transmission history (e.g., transmission status, transmission time), and intervention results (e.g., wandering prevention success/failure). Examples of AI output include optimized prevention algorithm parameters, wandering risk scores (e.g., 0.95), recommended alert transmission timing, and behavior restriction levels. These output values are used in subsequent processing by the prevention unit, such as real-time alert transmission, execution of behavior restrictions, and data transfer to the recording unit. As a technical effect, the prevention unit analyzes past wandering history with AI models and dynamically optimizes the prevention algorithm, greatly improving the accuracy of early detection of wandering signs and the speed and flexibility of prevention response compared to conventional fixed-parameter methods. This enables high-precision wandering prevention that responds to changes in the person's condition and individual characteristics. Application fields include monitoring of dementia patients, wandering prevention for psychiatric patients, home care support, and safety management in medical and care facilities. Furthermore, by changing analysis algorithms and parameter optimization methods, the system can flexibly accommodate various use cases and individual optimization. The prevention unit can adjust optimization logic and criteria for feature selection according to field requirements and individual characteristics, greatly enhancing the flexibility and scalability of computer technology.

The prevention unit can estimate the person's emotion and determine the priority of prevention based on the estimated emotion. For example, when the person is relaxed, the prevention unit can prevent wandering using gentle methods. When the person is feeling stressed, the prevention unit can prevent wandering using methods that reduce stress. Furthermore, when the person is excited, the prevention unit can prevent wandering using methods that calm the emotion. By determining the priority of prevention according to the person's emotion, appropriate wandering prevention can be achieved. Emotion estimation is realized, for example, by using an emotion engine or an emotion estimation function utilizing generative AI. Generative AI may include text generation AI (e.g., LLM) or multimodal generative AI, but is not limited to these examples. Specifically, the prevention unit acquires the person's utterance audio data, text data, vital sensor data (e.g., heart rate, blood pressure, body temperature), accelerometer data, and GPS location information in real time, and inputs these to the emotion estimation module. The emotion estimation module uses a BERT-based emotion classification model or a multimodal emotion estimation model that integrates audio, text, and biometric information. Examples of input to the AI include utterance text (e.g., “I'm feeling good today”, “I'm already tired”), audio features (e.g., F0=120 Hz, energy=0.8), vital data (e.g., heart rate 80 bpm, blood pressure 120/80), and acceleration values (e.g., 0.2, 0.1, 0.3). The AI outputs emotion labels (e.g., relaxed, stressed, excited) and emotion intensity scores (e.g., relaxed 0.8, stressed 0.1, excited 0.1) from these inputs. The prevention unit dynamically determines prevention priority scores (e.g., high, medium, low) and prevention method parameters (e.g., alert intensity, notification recipient, behavior restriction level) based on emotion labels and intensity scores. When the person is relaxed, gentle voice guidance or vibration and other low-stimulation alerts are prioritized for the person; when stressed, notification frequency and alert intensity are lowered to avoid amplifying stress, and notification to family or caregivers is prioritized; when excited, voice messages to calm emotion or relaxation-inducing audio are played, and emergency notification is performed as needed. Examples of AI output include prevention priority labels (e.g., high, medium, low), prevention method labels (e.g., gentle, stress reduction, emotion stabilization), alert intensity (e.g., low, medium, high), and notification recipient lists (e.g., person, family, security company). These output values are used in subsequent processing by the prevention unit, such as alert transmission, execution of behavior restrictions, and data transfer to the recording unit. As a technical effect, the prevention unit dynamically optimizes prevention priority and methods according to the person's emotional state, thereby achieving high-precision wandering prevention while reducing psychological burden compared to conventional uniform alert methods. This enables safety assurance and QOL improvement for the person, and reduction of caregiver burden. Application fields include monitoring of dementia patients, monitoring of psychiatric patients, home care support, and wandering prevention in medical and care facilities. Furthermore, by changing the types and parameters of emotion estimation models and prevention priority determination algorithms, the system can flexibly accommodate various use cases and individual optimization. The prevention unit can adjust prevention priority determination logic and criteria for setting alert intensity according to field requirements and individual characteristics, greatly enhancing the flexibility and scalability of computer technology.

The prevention unit can perform weighting of prevention data based on the timing of wandering occurrence at the time of prevention. For example, the prevention unit can place emphasis on recent wandering data when preventing wandering. The prevention unit can also place emphasis on important past wandering data when preventing wandering. Furthermore, the prevention unit can place emphasis on wandering data related to specific events when preventing wandering. By performing weighting of prevention data based on the timing of wandering occurrence, appropriate wandering prevention can be achieved. Specifically, the prevention unit obtains metadata such as timestamps for each wandering event (e.g., 2024-06-01 02:15:00), occurrence location, movement route, emotion score, and event tags (e.g., nighttime, holiday, before/after outing) from the wandering history database, and uses time-series sorting algorithms or priority queues to weight recent wandering data and event-related wandering data as input to the prevention algorithm. Examples of input to the AI include wandering occurrence time (e.g., 2024-06-01 02:15:00), occurrence location (e.g., around home, in front of station), event tags (e.g., holiday, before outing), and importance scores (e.g., 0.95, 0.2). The AI outputs prevention weight scores (e.g., 0.9, 0.3) and prevention priority labels (e.g., high, medium, low) based on occurrence timing and event tags. The prevention unit performs multi-stage prevention processing such as alert transmission and behavior restriction in order from wandering data with high weighting scores. For important past wandering events, importance estimation using TF-IDF or BERT embedding vectors is combined, and those with high importance are preferentially re-analyzed or re-prevented. For wandering data related to specific events, the proximity of event occurrence time and wandering time and the relevance of content are calculated, and weighting is dynamically adjusted. These output values are used in subsequent processing by the prevention unit, such as alert transmission, execution of behavior restrictions, and determining the order of data transfer to the recording unit. As a technical effect, the prevention unit greatly improves the speed of extracting important information and situational responsiveness compared to conventional simple time-series prevention methods by dynamically controlling weighting based on wandering occurrence timing and event relevance. This enables caregivers and medical professionals to access necessary information in real time, allowing for rapid decision-making and response. Application fields include monitoring of dementia patients, patient status recognition in medical settings, home care support, and emergency response systems. Furthermore, by changing the weighting algorithms and event tag assignment methods, the system can flexibly accommodate various use cases and individual optimization. The prevention unit can adjust the weighting and threshold settings of weighting scores according to field requirements and individual characteristics, greatly enhancing the flexibility and scalability of computer technology.

The system according to the embodiment is not limited to the examples described above and can be variously modified as follows. Specifically, the system can flexibly change the configuration of each module such as the collection unit, analysis unit, estimation unit, prevention unit, and recording unit, as well as the data flow, according to the characteristics of the usage environment and the target person. For example, in the collection unit, image sensors or environmental sensors (e.g., temperature, humidity, illuminance, CO2 concentration, etc.) can be added in addition to audio sensors to realize multimodal data collection. In the analysis unit, advanced AI models such as Transformer-based natural language processing models or graph neural networks can be introduced to enhance high-dimensional feature extraction and analysis of utterance content and behavioral patterns. In the estimation unit, ensemble estimation methods combining multiple estimation algorithms (e.g., decision tree, random forest, SVM, deep learning models) can be adopted to improve estimation accuracy and robustness. In the prevention unit, functions such as fall prediction and emergency notification can be added in addition to wandering prevention to realize comprehensive safety management. In the recording unit, functions to enhance security such as cloud linkage, distributed recording on edge devices, data encryption, and anonymization can be added. Furthermore, by dynamically optimizing AI model training data and parameters according to field requirements and individual characteristics, personalized support and application to various use cases can be achieved. As a technical effect, the system enables significant technical improvements in all aspects including scalability, adaptability, security, accuracy, and responsiveness compared to conventional fixed-function systems by allowing flexible changes to the configuration, algorithms, and data flow of each module. This enables application in a wide range of fields such as monitoring of dementia patients, monitoring of psychiatric patients, home care support, patient status recognition in medical settings, life support robots, and health management applications. Furthermore, by adding variations of AI models and data flows, the system can flexibly respond to future technological evolution and new use cases.

The collection unit can collect not only the person's utterances but also ambient environmental sounds. For example, the collection unit can measure ambient noise levels and temporarily suspend utterance collection when noise is high. The collection unit can also analyze ambient sounds and prioritize utterance collection when specific sounds (e.g., ambulance siren or doorbell) are detected. Furthermore, the collection unit can analyze ambient audio data and record audio events related to the person's utterances. By considering ambient environmental sounds, the accuracy of utterance collection can be improved. Specifically, the collection unit uses high-sensitivity microphone arrays and environmental sensors to acquire ambient acoustic data (e.g., 16 kHz, 16 bit, monaural PCM) in real time and performs preprocessing with an acoustic feature extraction module (e.g., spectrogram, MFCC, zero-crossing rate, etc.). The collection unit inputs acoustic features to an environmental sound classification model (e.g., CNN-based acoustic event detection model) to determine noise level (e.g., dB value), sound source type (e.g., siren, doorbell, speech, noise, etc.), and timing of audio event occurrence. Examples of input to the AI include acoustic feature vectors (e.g., MFCC 13 dimensions×time series), environmental sound labels (e.g., siren, doorbell), and noise level (e.g., 75 dB). Examples of AI output include noise judgment flags (e.g., high/low), audio event detection labels (e.g., siren detected, doorbell detected), and utterance collection permission flags (e.g., 1 or 0). The collection unit implements an algorithm that temporarily suspends utterance collection when the noise judgment flag is high and prioritizes utterance collection when an audio event is detected. Furthermore, audio events that occur simultaneously with the person's utterances (e.g., siren sound during speech) are recorded in time series and transferred to the analysis unit or recording unit, enabling high-precision understanding of the relationship between utterance content and environmental sounds. As a technical effect, the collection unit analyzes ambient environmental sounds with AI models and dynamically optimizes utterance collection timing and priority, greatly improving noise resistance, information comprehensiveness, and situational responsiveness compared to conventional simple utterance collection methods. This enables important utterances to be collected even in noisy environments or emergencies, increasing practicality in care and medical settings. Application fields include monitoring of dementia patients, home care support, patient status recognition in medical settings, and life support robots. Furthermore, by changing the types and parameters of acoustic event detection models and collection control algorithms, the system can flexibly accommodate various use cases and individual optimization. The collection unit can adjust collection control logic and criteria for selecting acoustic features according to field requirements and individual characteristics, greatly enhancing the flexibility and scalability of computer technology.

The recording unit can automatically back up the person's lifelog data to the cloud. For example, the recording unit can upload lifelog data to the cloud at regular intervals. The recording unit can also move old data to the cloud to secure storage when the person's device storage capacity is insufficient. Furthermore, the recording unit can synchronize data on the cloud with other devices, allowing access to lifelog data from multiple devices. By doing so, the safety and accessibility of lifelog data can be improved. Specifically, the recording unit stores lifelog data such as activity history, health data, utterance content, emotion transitions, and location information in a time-series database and automatically uploads it to a cloud storage service at regular intervals (e.g., every 5 minutes, 1 hour, or 1 day). The recording unit is equipped with a storage capacity monitoring module, and when local storage free space falls below a threshold, old data (e.g., older than one month) is automatically moved to the cloud to secure local storage. Lifelog data on the cloud is synchronized in real time with multiple devices such as family terminals, medical professional terminals, and caregiver terminals via a data synchronization module, and viewing/editing permissions are controlled for each user via an access rights management module. Examples of input to the AI include lifelog data (e.g., steps, heart rate, utterance content), recording time, remaining storage capacity, and list of synchronization destination devices. Examples of AI output include backup execution flags (e.g., 1 or 0), data transfer recommendation labels (e.g., move to cloud, keep local), and synchronization execution flags (e.g., 1 or 0). These output values are used in subsequent processing by the recording unit, such as cloud upload, data transfer, synchronization execution, and access rights settings. As a technical effect, the recording unit controls automatic backup, synchronization, and storage optimization of lifelog data with AI models, greatly improving data safety, availability, accessibility, and storage efficiency compared to conventional manual backup methods. This reduces the risk of data loss, enables real-time access from multiple locations, and facilitates information sharing in medical and care settings. Application fields include monitoring of dementia patients, home care support, health management applications, and medical data linkage platforms. Furthermore, by changing backup/synchronization algorithms and access rights management methods, the system can flexibly accommodate various use cases and individual optimization. The recording unit can adjust backup frequency and criteria for data transfer according to field requirements and individual characteristics, greatly enhancing the flexibility and scalability of computer technology.

The prevention unit can learn the person's behavioral patterns and detect signs of wandering. For example, the prevention unit can learn the person's usual movement routes and issue alerts when abnormal movement patterns are detected. The prevention unit can also analyze the person's behavioral history and identify time periods when wandering is likely to occur. Furthermore, the prevention unit can predict situations with high risk of wandering based on the person's behavioral patterns and take preventive measures in advance. By detecting signs of wandering and responding early, the person's safety can be ensured. Specifically, the prevention unit records movement route data (e.g., time-series vectors of latitude, longitude, and altitude) obtained from GPS modules or Wi-Fi/Bluetooth beacons, accelerometer data, and vital data (e.g., heart rate, stress score) in time series, and inputs these data to time-series convolutional neural networks (TCN) or LSTM and other time-series AI models. The AI learns usual movement route patterns (e.g., home-park-supermarket-home) and outputs an alert transmission flag when abnormal movement patterns (e.g., nighttime outings, large deviations from usual routes, long-distance movement in a short time) are detected. Examples of input to the AI include movement route vectors (e.g., GPS coordinate sequences), movement speed series, behavioral history (e.g., past week), and vital data series (e.g., heart rate 80 bpm, 90 bpm, . . . ). Examples of AI output include abnormal behavior detection flags (e.g., 1 or 0), wandering risk scores (e.g., 0.85), and recommended alert transmission timing. When the wandering risk score exceeds a threshold, the prevention unit automatically executes measures such as alert transmission, behavior restriction, and notification to family or caregivers. Furthermore, by using time-series clustering or autoregressive models for behavioral history, the prevention unit identifies time periods when wandering is likely to occur (e.g., 1:00-3:00 a.m., weekend afternoons) and dynamically adjusts monitoring intensity and alert thresholds during those periods. As a technical effect, the prevention unit greatly improves the accuracy of wandering sign detection, response speed, and individual optimization compared to conventional simple location monitoring methods by high-dimensional time-series data analysis and pattern learning with AI models. This enables safety assurance for the person, reduction of caregiver burden, and prevention of wandering accidents. Application fields include monitoring of dementia patients, wandering prevention for psychiatric patients, home care support, and safety management in medical and care facilities. Furthermore, by changing behavioral pattern learning models and abnormality detection algorithms and parameters, the system can flexibly accommodate various use cases and individual optimization. The prevention unit can adjust monitoring intensity and criteria for setting alert thresholds according to field requirements and individual characteristics, greatly enhancing the flexibility and scalability of computer technology.

The collection unit can estimate the person's emotion and adjust the method of collecting utterances based on the estimated emotion. For example, when the person is relaxed, the collection unit can collect utterances in natural conversation. When the person is feeling stressed, the collection unit can collect utterances in a question format. Furthermore, when the person is excited, the collection unit can collect utterances at short intervals. By adjusting the method of collecting utterances according to the person's emotion, more natural utterances can be collected. Specifically, the collection unit acquires the person's utterance audio data, text data, vital sensor data (e.g., heart rate, blood pressure, skin potential), and accelerometer data in real time, and inputs these multidimensional data to the emotion estimation module. The emotion estimation module uses a BERT-based emotion classification model or a multimodal emotion estimation model that integrates audio and biometric information (e.g., a Transformer-based model that simultaneously inputs audio features and vital data). Examples of input to the AI include utterance text (e.g., “I'm feeling good today”, “I'm already tired”), audio feature vectors (e.g., F0=120 Hz, energy=0.8, spectral envelope=0.6), vital data (e.g., heart rate 80 bpm, blood pressure 120/80), and acceleration values (e.g., 0.2, 0.1, 0.3). The AI outputs emotion labels (e.g., relaxed, stressed, excited) and emotion intensity scores (e.g., relaxed 0.8, stressed 0.1, excited 0.1) from these inputs. The collection unit dynamically determines collection method parameters (e.g., conversational, question-based, interval-shortening) based on emotion labels and intensity scores. When the person is relaxed, the flow of natural conversation is emphasized, and the threshold of the utterance detection algorithm is lowered to preferentially collect spontaneous utterances. When the person is stressed, AI-generated question sentences (e.g., “Is there anything you've been concerned about lately?”) are presented at appropriate timing to collect utterances in a guided manner. When the person is excited, the interval for utterance detection is shortened, and multiple utterances are collected in a short time to obtain detailed time-series data of emotional changes. Examples of AI output include collection method labels (e.g., natural conversation, question guidance, interval shortening), collection frequency (e.g., 1 minute, 30 seconds), and collection permission flags (e.g., 1 or 0). These output values are used in subsequent processing by the collection unit, such as data transfer to the recording unit, selection of input data for the analysis unit, and parameter setting for the collection scheduler. As a technical effect, the collection unit quantitatively evaluates the person's emotional state in a high-dimensional vector space and dynamically optimizes the collection method, greatly reducing psychological burden and achieving high-precision utterance collection suited to the situation compared to conventional uniform collection methods. This enables improved comprehensiveness of natural utterance data, early detection of abnormal behavior and emotional changes, and increased practicality in care and medical settings. Application fields include monitoring of dementia patients, monitoring of psychiatric patients, home care support, health management applications, and life support robots. Furthermore, by changing the types and parameters of emotion estimation models and collection method control algorithms, the system can flexibly accommodate various use cases and individual optimization. The collection unit can adjust collection method switching logic and criteria for setting collection frequency according to field requirements and individual characteristics, greatly enhancing the flexibility and scalability of computer technology.

The collection unit can analyze the person's past utterance history and select the optimal collection timing. For example, the collection unit can set the collection timing based on time periods when the person frequently uttered in the past. The collection unit can also analyze the person's past utterance content and preferentially collect important utterances. Furthermore, the collection unit can optimize the collection method based on the person's past utterance patterns. By analyzing past utterance history, the optimal collection timing can be selected. Specifically, the collection unit maintains a time-series database of the person's utterance history for the past week to month (e.g., utterance time, utterance content, emotion score, utterance length, utterance frequency), and inputs these data to time-series clustering, autoregressive models (AR models), or LSTM and other time-series neural networks to automatically extract peak time periods of utterance frequency and utterance patterns (e.g., morning chats, nighttime anxious utterances, weekend desire to go out, etc.). Examples of input to the AI include past utterance text sequences (e.g., “Help me”, “I want to go outside”, “The weather is nice today”), utterance time series (e.g., 2024-06-01 10:15, 2024-06-01 12:30, . . . ), and emotion score series (e.g., 0.8, 0.2, 0.1, . . . ). The AI outputs recommended collection timing values (e.g., 8:00-10:00 a.m., 8:00-10:00 p.m.), collection priority scores (e.g., 0.95, 0.2), and collection method labels (e.g., normal, focused, simple) based on extracted patterns and features. The collection unit increases collection frequency during peak time periods and applies detailed collection methods during time periods with many important utterances. Importance scores of utterance content and patterns of emotion score fluctuations are also considered, and the collection method is automatically switched when abnormal patterns occur. Examples of AI output include optimized collection algorithm parameters, collection confidence scores (e.g., 0.95), and recommended collection timing values (e.g., 20:00-22:00). These output values are used in subsequent processing by the collection unit, such as data transfer to the recording unit, selection of input data for the analysis unit, and parameter setting for the collection scheduler. As a technical effect, the collection unit analyzes past utterance history with AI models and dynamically optimizes collection timing and methods, greatly improving the comprehensiveness and accuracy of information compared to conventional fixed-parameter methods. This enables high-precision utterance collection that responds to changes in the person's condition and individual characteristics. Application fields include monitoring of dementia patients, monitoring of psychiatric patients, home care support, patient status recognition in medical settings, and more. Furthermore, by changing analysis algorithms and parameter optimization methods, the system can flexibly accommodate various use cases and individual optimization. The collection unit can adjust optimization logic and criteria for feature selection according to field requirements and individual characteristics, greatly enhancing the flexibility and scalability of computer technology.

The collection unit can adjust the method of collecting utterances based on the person's living conditions and areas of interest. For example, the collection unit can preferentially collect utterances related to topics the person is currently interested in. The collection unit can also adjust the content of utterances to be collected according to the person's living conditions. Furthermore, the collection unit can filter and collect utterances related to the person's current activities. By filtering utterances based on the person's living conditions and areas of interest, highly relevant utterances can be collected. Specifically, the collection unit integrally manages the person's living condition data (e.g., living arrangement, family structure, occupation, daily routine), areas of interest data (e.g., hobbies, health, news, travel, etc.), and current activity data (e.g., walking, eating, resting), and inputs these as feature vectors to the AI model. Examples of input to the AI include living condition vectors (e.g., single, elderly, at home), list of interest topics (e.g., gardening, cooking, health), activity labels (e.g., walking, watching TV), and utterance text (e.g., “I want to plant new flowers”, “I'm not feeling well lately”). The AI quantifies the relevance between input features and utterance content using BERT embedding vectors or cosine similarity calculations, and outputs relevance scores (e.g., 0.92), priority labels (e.g., high, medium, low), and collection permission flags (e.g., 1 or 0). The collection unit preferentially collects utterances with high relevance scores and dynamically adjusts collection targets and frequency according to living conditions and activity content. For example, when the person is interested in health, health-related utterances are preferentially collected; when traveling, utterances related to movement and outings are preferentially collected. The AI output values are used in subsequent processing by the collection unit, such as data transfer to the recording unit and selection of input data for the analysis unit. As a technical effect, the collection unit quantitatively evaluates living conditions, areas of interest, and activity content in a high-dimensional vector space and dynamically optimizes the method of collecting utterances, greatly improving high-precision information collection suited to the person's current situation compared to conventional uniform collection methods. This suppresses unnecessary data accumulation and enables efficient analysis/estimation processing and improved system responsiveness. Application fields include monitoring of dementia patients, situation recognition in medical and care facilities, dialogue optimization for life support robots, and community-linked health management systems. Furthermore, by changing living condition data and relevance calculation algorithms, the system can flexibly accommodate various use cases and individual optimization. The collection unit can adjust collection control logic and criteria for setting relevance thresholds according to field requirements and individual characteristics, greatly enhancing the flexibility and scalability of computer technology.

The collection unit can estimate the person's emotion and determine the priority of utterances to be collected based on the estimated emotion. For example, when the person is relaxed, the collection unit can preferentially collect daily utterances. When the person is feeling stressed, the collection unit can preferentially collect emotional utterances. Furthermore, when the person is excited, the collection unit can preferentially collect important utterances. By determining the priority of utterances to be collected according to the person's emotion, important utterances can be preferentially collected. Specifically, the collection unit acquires the person's utterance audio data, text data, vital sensor data, and accelerometer data in real time, and inputs these to the emotion estimation module. The emotion estimation module uses a BERT-based emotion classification model or a multimodal emotion estimation model that integrates audio and biometric information. Examples of input to the AI include utterance text (e.g., “I'm feeling good today”, “I'm already tired”), audio features (e.g., F0=120 Hz, energy=0.8), vital data (e.g., heart rate 80 bpm, blood pressure 120/80), and acceleration values (e.g., 0.2, 0.1, 0.3). The AI outputs emotion labels (e.g., relaxed, stressed, excited) and emotion intensity scores (e.g., relaxed 0.8, stressed 0.1, excited 0.1) from these inputs. The collection unit dynamically determines utterance priority scores (e.g., high, medium, low) and collection target labels (e.g., daily, emotional, important) based on emotion labels and intensity scores. When the person is relaxed, daily utterances (e.g., “The weather is nice today”) are preferentially collected; when stressed, emotional utterances (e.g., “I can't take it anymore”, “Help me”) are preferentially collected; when excited, important utterances (e.g., “I want to go outside”, “I don't know where I am”) are collected with the highest priority. The AI output values are used in subsequent processing by the collection unit, such as data transfer to the recording unit, selection of input data for the analysis unit, and parameter setting for the collection scheduler. As a technical effect, the collection unit quantitatively evaluates the person's emotional state in a high-dimensional vector space and dynamically optimizes the priority of utterances, greatly improving the comprehensiveness of important information and system responsiveness compared to conventional uniform collection methods. This enables caregivers and medical professionals to provide information for rapid and accurate response. Application fields include monitoring of dementia patients, monitoring of psychiatric patients, home care support, and patient status recognition in medical settings. Furthermore, by changing the types and parameters of emotion estimation models and priority determination algorithms, the system can flexibly accommodate various use cases and individual optimization. The collection unit can adjust priority determination logic and criteria for setting thresholds according to field requirements and individual characteristics, greatly enhancing the flexibility and scalability of computer technology.

The collection unit can adjust the method of collecting utterances based on the person's geographic location information. For example, when the person is in a specific location, the collection unit can preferentially collect utterances related to that location. The collection unit can also preferentially collect utterances related to the destination when the person is moving. Furthermore, when the person is in a specific region, the collection unit can preferentially collect utterances related to that region. By considering geographic location information, highly relevant utterances can be preferentially collected. Specifically, the collection unit acquires geographic location data (e.g., time-series vectors of latitude, longitude, and altitude), movement route data, and current location labels (e.g., home, hospital, park, supermarket, etc.) in real time from GPS modules or Wi-Fi/Bluetooth beacons, and inputs these as feature vectors to the AI model. Examples of input to the AI include current location labels (e.g., home, hospital), movement route vectors (e.g., GPS coordinate sequences), and utterance text (e.g., “I want to go outside”, “I want to go to the hospital”). The AI quantifies the relevance between geographic location information and utterance content using BERT embedding vectors or cosine similarity calculations, and outputs relevance scores (e.g., 0.92), priority labels (e.g., high, medium, low), and collection permission flags (e.g., 1 or 0). The collection unit preferentially collects utterances with high relevance scores and increases the frequency of collecting related utterances when in specific locations or while moving. For example, when the person is in a hospital, health and medical-related utterances are preferentially collected; when at an outing location such as a park or supermarket, utterances related to movement and shopping are preferentially collected. The AI output values are used in subsequent processing by the collection unit, such as data transfer to the recording unit and selection of input data for the analysis unit. As a technical effect, the collection unit quantitatively evaluates the relevance between geographic location information and utterance content in a high-dimensional vector space, greatly improving high-precision information collection suited to the person's current situation compared to conventional indiscriminate collection methods. This suppresses unnecessary data accumulation and enables efficient analysis/estimation processing and improved system responsiveness. Application fields include monitoring of dementia patients during outings, situation recognition in medical and care facilities, dialogue optimization for life support robots, and community-linked health management systems. Furthermore, by changing the interval for acquiring location information and relevance calculation algorithms, the system has scalability to flexibly accommodate various use cases such as urban, suburban, and indoor/outdoor environments. The collection unit can adjust location information linkage logic and criteria for setting relevance thresholds according to field requirements and individual characteristics, greatly enhancing the flexibility and scalability of computer technology.

The collection unit can analyze a person's social media activity and collect related utterances. For example, the collection unit can collect utterances related to topics on which the person frequently posts on social media. Additionally, the collection unit can set the timing of utterance collection based on the person's active hours on social media. Furthermore, the collection unit can analyze the content of the person's social media posts and preferentially collect important utterances. By analyzing social media activity, it is possible to collect related utterances. Specifically, the collection unit periodically acquires post history data (e.g., posting time, post content, number of reactions) via API from multiple social media platforms used by the person (e.g., microblogs, SNS, bulletin boards, etc.). The collection unit vectorizes post content using natural language embedding models such as BERT or RoBERTa and calculates the cosine similarity between the topic vectors of the person's utterances and social media posts to compute a relevance score. The collection unit clusters topics that the person frequently posts about (e.g., health, hobbies, family, news, etc.) and preferentially collects and records utterances that show high relevance to these topics. For activity time analysis, the posting time data for the past month is converted into a histogram, peak time periods (e.g., 8:00 PM to 10:00 PM) are automatically extracted, and reflected in the scheduling of utterance collection. For determining important utterances, importance estimation using TF-IDF scores or BERT embedding vectors is employed, and utterances similar to post content with high engagement (e.g., number of likes, comments) on the person's social media are preferentially collected. Examples of AI input include social media post text (e.g., “I started a new hobby today”, “I haven't been feeling well lately”), posting time (e.g., 2024-06-01 20:15), and utterance text (e.g., “I want to try a new hobby”). AI output includes relevance score (e.g., 0.92), priority label (e.g., high, medium, low), and recommended collection timing (e.g., 20:00-22:00). These output values are used in subsequent processing by the collection unit, such as data transfer to the recording unit, selection of input data for the analysis unit, and parameter setting for the collection scheduler. As a technical effect, the collection unit quantitatively evaluates the relevance between the person's social media activity and utterance content in a high-dimensional vector space, thereby achieving high-precision information collection tailored to the person's interests, concerns, and social activities, which is superior to conventional collection methods based solely on utterance content. This enables early detection of changes in the person's social connections and psychological state, improving the quality of care and medical support and enabling personalized health management. Applicable fields include prevention of social isolation in dementia patients, monitoring of patients with mental disorders, home care support, and personalized health management applications. Furthermore, by changing the types of social media APIs and relevance calculation algorithms, the system has extensibility to flexibly accommodate various platforms and use cases. The collection unit can adjust collection control logic and relevance threshold settings according to field requirements and individual characteristics, greatly enhancing the flexibility and scalability of computer technology.

The analysis unit can estimate the person's emotion and adjust the method of expressing the analysis based on the estimated emotion. For example, when the person is relaxed, the analysis unit can provide detailed analysis results. When the person is feeling stressed, the analysis unit can provide concise analysis results. Furthermore, when the person is excited, the analysis unit can provide visually easy-to-understand analysis results. By adjusting the method of expressing the analysis according to the person's emotion, appropriate analysis results can be provided. Emotion estimation is realized, for example, by using an emotion engine or generative AI with emotion estimation functions. Generative AI may include text generation AI (e.g., large language models) or multimodal generative AI, but is not limited to these examples. Specifically, the analysis unit acquires the person's utterance audio and text data in real time and inputs them into the emotion estimation module. The emotion estimation module uses a BERT-based emotion classification model or a multimodal emotion estimation model, receives as input utterance text (e.g., “I'm happy today”, “I'm tired already”) and audio features (e.g., F0, energy, spectral envelope), and outputs emotion labels (e.g., relaxed, stressed, excited) and emotion intensity scores (e.g., relaxed 0.8, stressed 0.2). The analysis unit dynamically switches the method of expressing the analysis results based on the emotion label and intensity score. When relaxed, a detailed report including semantic analysis of utterance content (e.g., topic extraction, intention estimation, emotion transition graph, etc.) is generated; when stressed, a concise summary extracting only key points (e.g., topic label, emotion label, important utterance list) is presented; and when excited, the analysis results are output in a visually emphasized interface (e.g., color-coded graphs, icon display, emotion change animation, etc.). Examples of AI input include utterance text (e.g., “I'm feeling good today”, “I want help”), audio feature vectors (e.g., F0=120 Hz, energy=0.8), and emotion intensity scores (e.g., 0.7, 0.2, 0.1). AI output includes analysis expression type (e.g., detailed, concise, visual), analysis result data (e.g., topic category, emotion transition graph, summary text), etc. These output values are used in subsequent processing by the analysis unit, such as selection of display format for the user interface and data transfer to the recording unit. As a technical effect, by optimizing the method of expressing analysis results according to the person's emotional state, the analysis unit provides information that is easier to understand and more situationally appropriate for the person and caregivers than conventional uniform output methods. This enables more efficient information transmission, stress reduction, and rapid decision support. Applicable fields include monitoring of dementia patients, monitoring of patients with mental disorders, home care support, and patient status reporting in medical settings. Furthermore, by changing the analysis expression algorithm and interface design, the system can flexibly accommodate various use cases and individual optimization. The analysis unit can adjust analysis expression control logic and output format selection criteria according to field requirements and individual characteristics, greatly enhancing the flexibility and scalability of computer technology.

The following is a brief description of the processing flow of Example of the Embodiment. Specifically, the system is composed of multiple modules such as a collection unit, analysis unit, estimation unit, prevention unit, and recording unit, and data flow is coordinated among the modules to consistently perform real-time collection, analysis, estimation, recording, and prevention processing of the person's utterance data and biometric information. The collection unit acquires utterance audio, text, vital data, location information, etc. from various sensors such as voice sensors, vital sensors, accelerometers, and GPS, and transfers the data to the emotion estimation module and utterance content analysis module. The analysis unit uses BERT, Transformer-based natural language processing models, multimodal emotion estimation models, etc., to perform multi-stage analysis such as semantic analysis of utterance content, emotion estimation, topic extraction, intention estimation, and emotion transition graph generation. The estimation unit receives output from the analysis unit (e.g., utterance text, emotion label, emotion intensity score, topic category) as input and estimates the person's intention (e.g., desire to go out, request for help, desire to rest, etc.) using estimation algorithms such as multilayer perceptrons, decision trees, and rule-based estimators. The prevention unit executes safety management processing such as wandering prevention, abnormal behavior prediction, alert transmission, and behavior restriction based on information from the estimation unit and recording unit. The recording unit records and backs up data from all modules in a time-series database or cloud storage and synchronizes data with family or medical staff terminals as needed. Each module can dynamically optimize AI model parameters and control algorithms according to field requirements and individual characteristics, enabling personalized support and application to various use cases. As a technical effect, the system achieves significant technical improvements in extensibility, adaptability, accuracy, responsiveness, and safety compared to conventional fixed-function systems through data coordination among modules and dynamic optimization by AI models. This enables application in a wide range of fields, including monitoring of dementia patients, monitoring of patients with mental disorders, home care support, patient status monitoring in medical settings, life support robots, and health management applications. Furthermore, by adding variations of AI models and data flows, the system can flexibly accommodate future technological advancements and new use cases.
Step 1: The collection unit collects the person's utterances in real time. For example, the collection unit can collect the person's utterances as audio data, text data, or gesture data. Step 2: The analysis unit analyzes the utterance data collected by the collection unit. For example, the analysis unit can convert audio data into text data using speech recognition technology. It can also analyze text data using text analysis technology, and further analyze the emotion of utterance data using emotion analysis technology. Step 3: The estimation unit estimates the person's intention based on the information analyzed by the analysis unit. For example, the estimation unit can estimate the person's decision-making, emotional state, or behavioral intention based on the analysis results. Specifically, in Step 1, the system acquires various data such as utterance audio, gestures, heart rate, etc., in real time from voice sensors, accelerometers, vital sensors, etc., and audio data is preprocessed by acoustic feature extraction modules such as spectrograms and MFCC. The collection unit inputs these feature vectors and text data into the AI model to perform utterance detection and utterance segment extraction. In Step 2, the analysis unit uses a speech recognition model (e.g., Transformer-based ASR) to convert audio data into text, and a natural language processing model such as BERT to perform topic extraction, intention estimation, and emotion estimation (e.g., relaxed, stressed, excited). Examples of AI input include audio feature vectors (e.g., MFCC 13 dimensions×time series), utterance text (e.g., “I want to go outside”, “Help me”), and vital data (e.g., heart rate 80 bpm). AI output includes utterance segment labels, topic categories, emotion labels, emotion intensity scores, etc. In Step 3, the estimation unit receives output from the analysis unit (e.g., topic category, emotion label, emotion intensity score) as input and estimates the person's intention (e.g., desire to go out, request for help, desire to rest, etc.) using estimation algorithms such as multilayer perceptrons and decision trees. Examples of AI output include intention labels (e.g., desire to go out, seeking help), estimation confidence scores (e.g., 0.92), and estimation detail labels (e.g., detailed, concise, urgent). These output values are used in subsequent processing, such as alert transmission and behavior restriction by the prevention unit, and data transfer to the recording unit. As a technical effect, the system achieves high-dimensional data analysis and dynamic optimization by AI models at each step, greatly improving information coverage, accuracy, responsiveness, and safety compared to conventional simple utterance collection, analysis, and estimation methods. This enables application in a wide range of fields, including monitoring of dementia patients, monitoring of patients with mental disorders, home care support, patient status monitoring in medical settings, and life support robots. Furthermore, by adding variations of AI models and data flows, the system can flexibly accommodate future technological advancements and new use cases.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the various elements including the collection unit, analysis unit, estimation unit, recording unit, and prevention unit may be implemented, for example, by at least one of the smart device 14 or the data processing device 12. For example, the collection unit may be implemented by the input device 38 of the smart device 14, and the collected utterance data may be displayed by the display 40. The analysis unit analyzes the utterance data displayed by the display 40, and the estimation unit estimates the person's intention based on the analyzed information. The recording unit records, via the input device 38 of the smart device 14, the person's activity history and health data, among other things. The prevention unit may be implemented by the input device 38 of the smart device 14, and functions such as location tracking and alert communication may be implemented. The correspondence between each unit and the devices or control units is not limited to the examples described above, and various modifications are possible.

### Second Embodiment

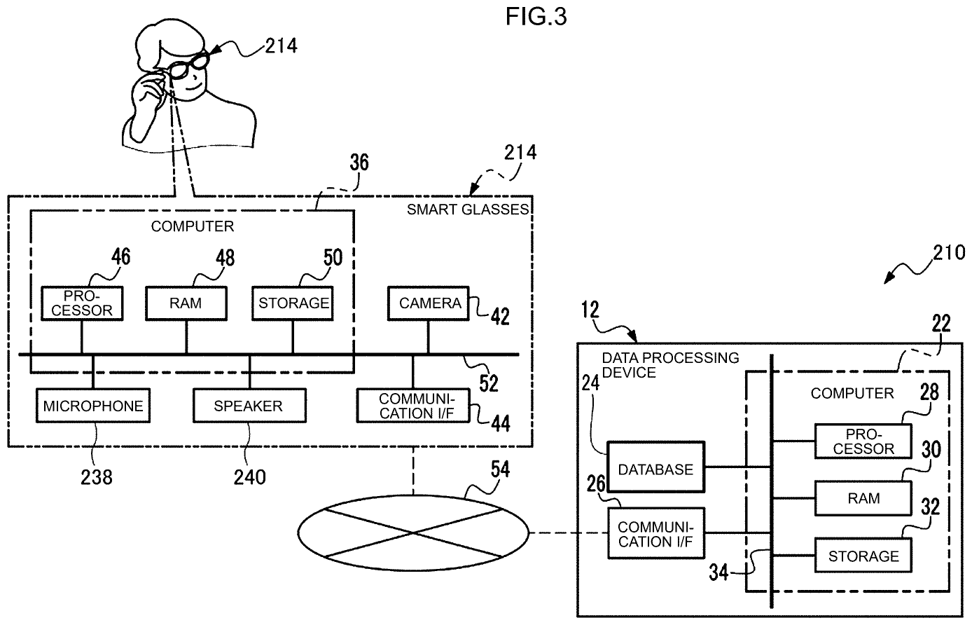

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

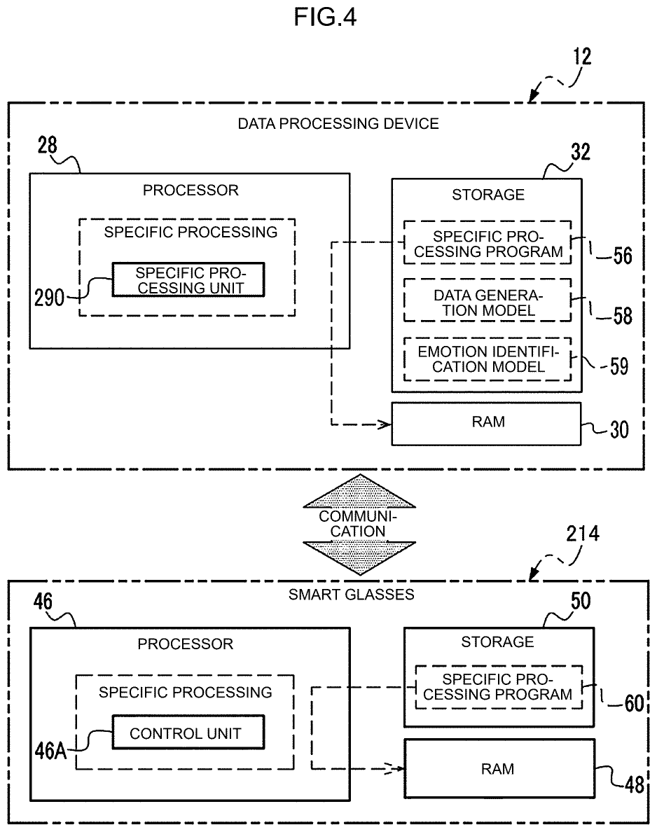

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the various elements including the collection unit, analysis unit, estimation unit, recording unit, and prevention unit may also be implemented, for example, by the smart glasses 214. For example, the collection unit may be implemented by the input device 38 of the smart glasses 214, and the collected utterance data may be displayed by the display 40. The analysis unit analyzes the utterance data displayed by the display 40, and the estimation unit estimates the person's intention based on the analyzed information. The recording unit records, via the input device 38 of the smart glasses 214, the person's activity history and health data, among other things. The prevention unit may be implemented by the input device 38 of the smart glasses 214, and functions such as location tracking and alert communication may be implemented. The correspondence between each unit and the devices or control units is not limited to the examples described above, and various modifications are possible.

### Third Embodiment

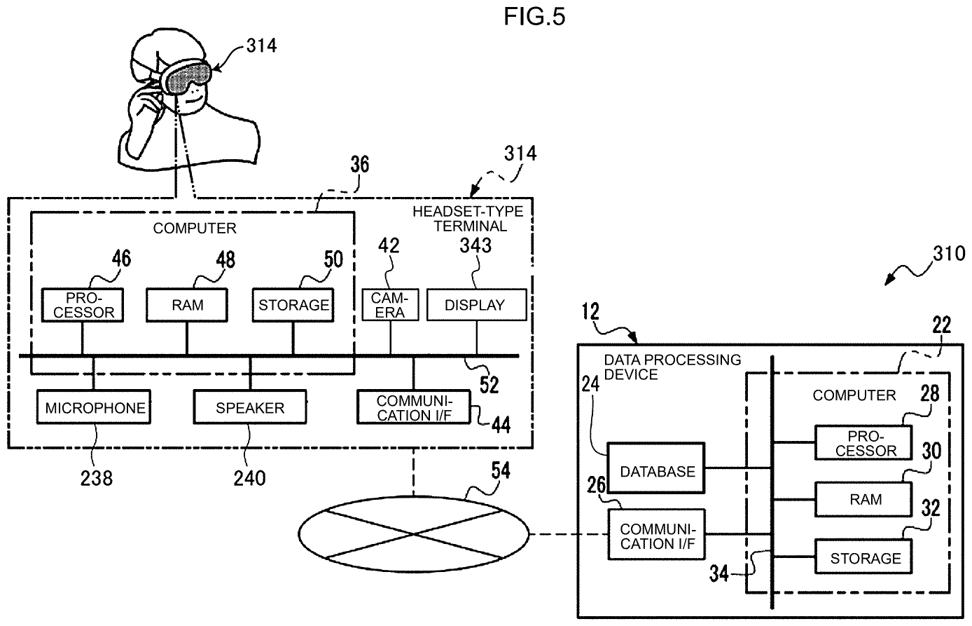

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

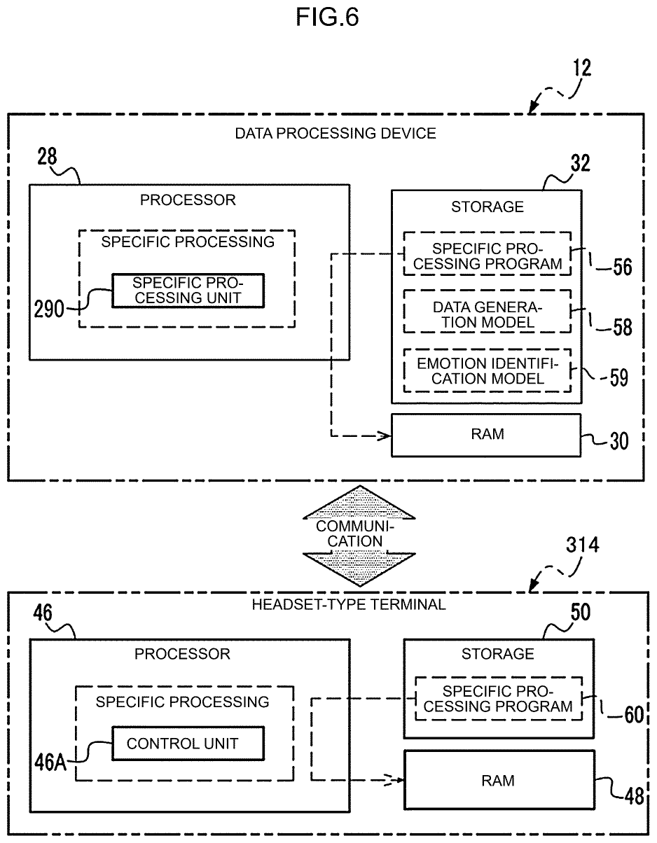

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the various elements including the collection unit, analysis unit, estimation unit, recording unit, and prevention unit may also be implemented, for example, by the headset-type device 314. For example, the collection unit may be implemented by the input device 38 of the headset-type device 314, and the collected utterance data may be displayed by the display 40. The analysis unit analyzes the utterance data displayed by the display 40, and the estimation unit estimates the person's intention based on the analyzed information. The recording unit records, via the input device 38 of the headset-type device 314, the person's activity history and health data, among other things. The prevention unit may be implemented by the input device 38 of the headset-type device 314, and functions such as location tracking and alert communication may be implemented. The correspondence between each unit and the devices or control units is not limited to the examples described above, and various modifications are possible.

### Fourth Embodiment

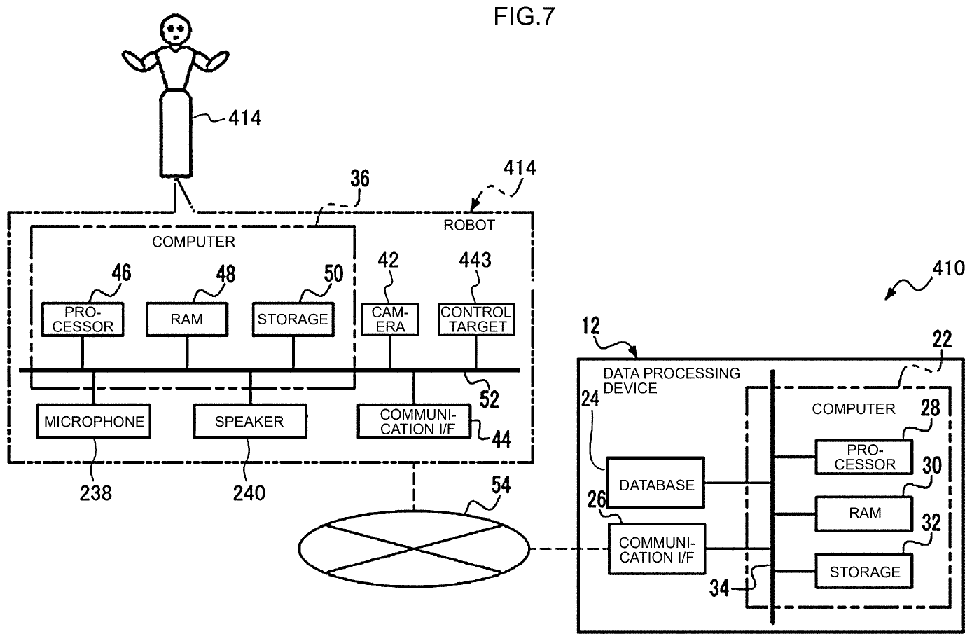

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

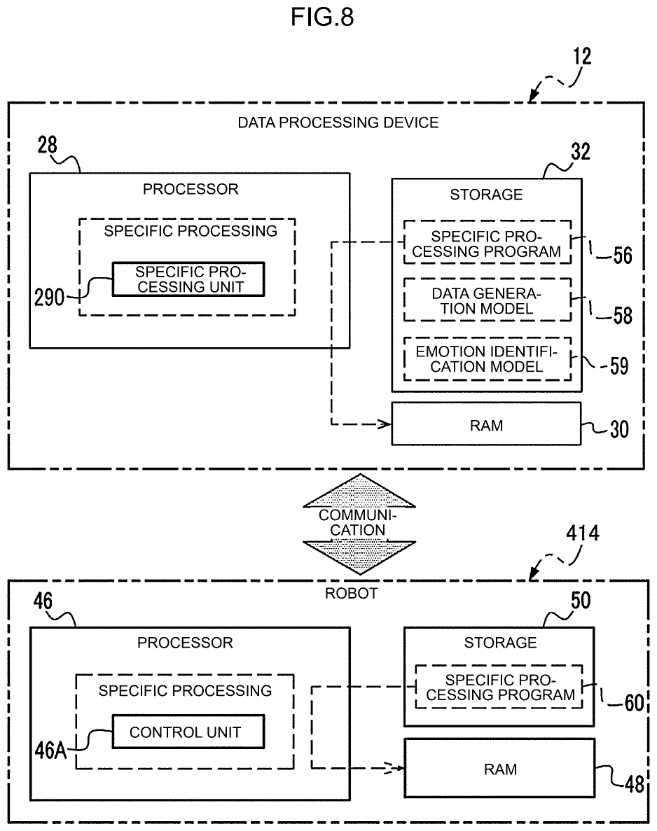

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the various elements including the collection unit, analysis unit, estimation unit, recording unit, and prevention unit may also be implemented, for example, by the robot 414. For example, the collection unit may be implemented by the input device 38 of the robot 414, and the collected utterance data may be displayed by the display 40. The analysis unit analyzes the utterance data displayed by the display 40, and the estimation unit estimates the person's intention based on the analyzed information. The recording unit records, via the input device 38 of the robot 414, the person's activity history and health data, among other things. The prevention unit may be implemented by the input device 38 of the robot 414, and functions such as location tracking and alert communication may be implemented. The correspondence between each unit and the devices or control units is not limited to the examples described above, and various modifications are possible.

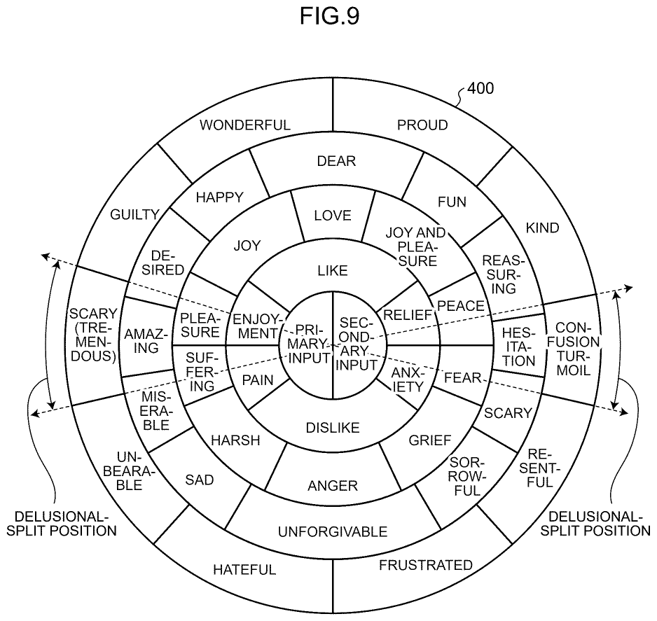

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

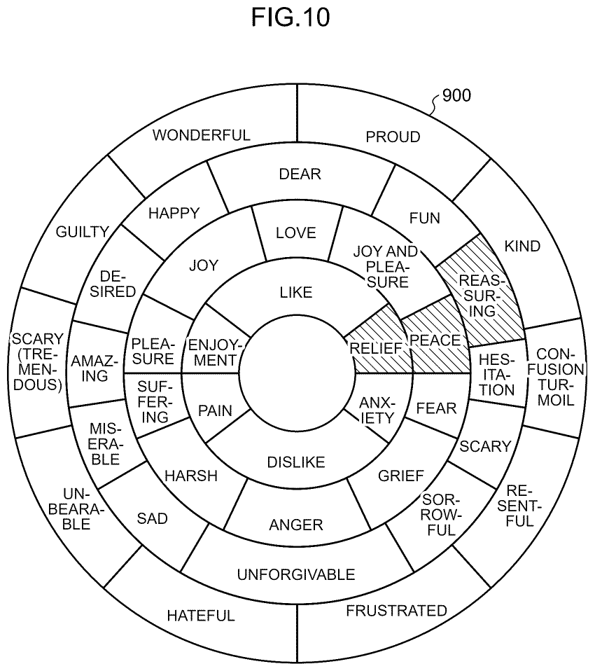

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a collection unit configured to collect a person's utterances in real time; an analysis unit configured to analyze utterance data collected by the collection unit; and an estimation unit configured to estimate the person's intention based on information analyzed by the analysis unit.
(Supplementary Note 2)The system according to Supplementary Note 1, further comprising a recording unit configured to record lifelogs.
(Supplementary Note 3)The system according to Supplementary Note 1, further comprising a prevention unit configured to implement a wandering prevention function.
(Supplementary Note 4)The system according to Supplementary Note 1, wherein the collection unit is configured to estimate the person's emotion and determine a method for adjusting the timing of utterance collection based on the estimated emotion.
(Supplementary Note 5)The system according to Supplementary Note 1, wherein the collection unit is configured to analyze the person's past utterance history and select an appropriate collection method.
(Supplementary Note 6)The system according to Supplementary Note 1, wherein the collection unit is configured to perform filtering at the time of utterance collection based on the person's living conditions and areas of interest.
(Supplementary Note 7)The system according to Supplementary Note 1, wherein the collection unit is configured to estimate the person's emotion and determine the priority of utterances to be collected based on the estimated emotion.
(Supplementary Note 8)The system according to Supplementary Note 1, wherein the collection unit is configured to preferentially collect highly relevant utterances at the time of utterance collection based on the person's geographic location information.
(Supplementary Note 9)The system according to Supplementary Note 1, wherein the collection unit is configured to analyze the person's social media activity at the time of utterance collection and collect related utterances.
(Supplementary Note 10)The system according to Supplementary Note 1, wherein the analysis unit is configured to estimate the person's emotion and determine a method of expressing the analysis based on the estimated emotion.
(Supplementary Note 11)The system according to Supplementary Note 1, wherein the analysis unit is configured to adjust the level of detail of the analysis based on the importance of the utterance at the time of analysis.
(Supplementary Note 12)The system according to Supplementary Note 1, wherein the analysis unit is configured to apply different analysis algorithms according to the category of the utterance at the time of analysis.
(Supplementary Note 13)The system according to Supplementary Note 1, wherein the analysis unit is configured to estimate the person's emotion and determine the length of the analysis based on the estimated emotion.
(Supplementary Note 14)The system according to Supplementary Note 1, wherein the analysis unit is configured to determine the priority of the analysis based on the submission timing of the utterance at the time of analysis.
(Supplementary Note 15)The system according to Supplementary Note 1, wherein the analysis unit is configured to adjust the order of the analysis based on the relevance of the utterance at the time of analysis.
(Supplementary Note 16)The system according to Supplementary Note 1, wherein the estimation unit is configured to estimate the person's emotion and determine a method for estimating the intention based on the estimated emotion.
(Supplementary Note 17)The system according to Supplementary Note 1, wherein the estimation unit is configured to optimize the estimation algorithm by referring to past utterance data at the time of estimation.
(Supplementary Note 18)The system according to Supplementary Note 1, wherein the estimation unit is configured to apply different estimation methods according to the category of the utterance at the time of estimation.
(Supplementary Note 19)The system according to Supplementary Note 1, wherein the estimation unit is configured to estimate the person's emotion and determine a method for determining the priority of estimation based on the estimated emotion.
(Supplementary Note 20)The system according to Supplementary Note 1, wherein the estimation unit is configured to perform weighting of the estimation based on the submission timing of the utterance at the time of estimation.
(Supplementary Note 21)The system according to Supplementary Note 1, wherein the estimation unit is configured to refer to relevant market data of the utterance at the time of estimation.
(Supplementary Note 22)The system according to Supplementary Note 2, wherein the recording unit is configured to estimate the person's emotion and determine a method for recording lifelogs based on the estimated emotion.
(Supplementary Note 23)The system according to Supplementary Note 2, wherein the recording unit is configured to optimize the recording algorithm by referring to past lifelog data at the time of recording.
(Supplementary Note 24)The system according to Supplementary Note 2, wherein the recording unit is configured to estimate the person's emotion and determine the frequency of recording based on the estimated emotion.
(Supplementary Note 25)The system according to Supplementary Note 2, wherein the recording unit is configured to perform weighting of the recorded data based on the submission timing of the lifelog at the time of recording.
(Supplementary Note 26)The system according to Supplementary Note 3, wherein the prevention unit is configured to estimate the person's emotion and determine a method for preventing wandering based on the estimated emotion.
(Supplementary Note 27)The system according to Supplementary Note 3, wherein the prevention unit is configured to optimize the prevention algorithm by referring to past wandering data at the time of prevention.
(Supplementary Note 28)The system according to Supplementary Note 3, wherein the prevention unit is configured to estimate the person's emotion and determine a method for determining the priority of prevention based on the estimated emotion.
(Supplementary Note 29)The system according to Supplementary Note 3, wherein the prevention unit is configured to perform weighting of the prevention data based on the occurrence timing of wandering at the time of prevention.

What is claimed is:

1. A system comprising:
circuitry configured to:
receive, from a client terminal via a packet-switched network, audio data captured by a microphone of the client terminal;
convert the audio data into text data by inputting the audio data into a speech recognition model comprising a Transformer-based neural network;
generate, by inputting the text data into an emotion identification model, an emotion label and an emotion intensity score;
generate, by inputting the text data, the emotion label, and the emotion intensity score into a data generation model comprising a neural network obtained by deep learning, inference data indicating an estimated intention; and
transmit the inference data to the client terminal via the packet-switched network.

2. The system according to claim 1, wherein the circuitry is further configured to record time-series data comprising the text data, the emotion label, the emotion intensity score, and the inference data in a time-series database.

3. The system according to claim 1, wherein the circuitry is further configured to:
receive, from the client terminal, location data indicating a current position of the client terminal;
determine whether the current position deviates from a predefined safe area; and
transmit, in response to determining that the current position deviates from the predefined safe area, an alert signal to a caregiver terminal via the packet-switched network.

4. The system according to claim 1, wherein the circuitry is further configured to dynamically adjust a collection frequency parameter for the audio data based on the emotion intensity score, such that the collection frequency parameter is set to a first value when the emotion label indicates a relaxed state and a second value shorter than the first value when the emotion label indicates an excited state.

5. The system according to claim 1, wherein the circuitry is further configured to:
maintain a time-series database of past text data associated with timestamps; and
extract, by inputting the past text data into a time-series neural network comprising a long short-term memory network, a peak time period of utterance frequency, wherein the collection frequency parameter is increased during the peak time period.

6. The system according to claim 1, wherein the circuitry is further configured to:
compute a relevance score by calculating a cosine similarity between a feature vector of the text data generated by a natural language embedding model and an interest profile vector associated with the client terminal; and
selectively store the text data in a database in response to the relevance score exceeding a predefined threshold.

7. The system according to claim 1, wherein the circuitry is further configured to determine a priority label for the text data based on the emotion label, such that text data associated with an emotion label indicating a stressed state is assigned a higher priority label than text data associated with an emotion label indicating a relaxed state.

8. The system according to claim 1, wherein the circuitry is further configured to:
receive, from the client terminal, location data comprising latitude, longitude, and altitude values obtained from a GPS module of the client terminal; and
compute a location-based relevance score by calculating a similarity between a location information vector derived from the location data and a feature vector of the text data, wherein text data having a location-based relevance score above a threshold is preferentially processed.

9. The system according to claim 1, wherein the speech recognition model converts the audio data into a spectrogram, applies noise reduction processing, and generates the text data as a sequence of utterance texts from the spectrogram.

10. The system according to claim 1, wherein the emotion identification model comprises a BERT-based emotion classification model that receives the text data and audio feature data comprising fundamental frequency, energy, and spectral envelope values as input, and generates the emotion label selected from a plurality of predefined emotion categories and the emotion intensity score as output.

11. The system according to claim 1, wherein the data generation model comprises a generative AI model that receives a prompt containing instructions and the text data, the emotion label, and the emotion intensity score as inference data, and outputs the inference data indicating the estimated intention in at least one of text data or voice data.

12. The system according to claim 1, wherein the circuitry is further configured to:
classify the text data into an utterance category by inputting the text data into a category classification model; and
select an analysis algorithm from a plurality of analysis algorithms based on the utterance category, wherein the selected analysis algorithm is applied to generate the inference data.

13. The system according to claim 1, wherein the circuitry is further configured to dynamically determine an analysis detail level parameter based on the emotion label, such that a detailed analysis is generated when the emotion label indicates a relaxed state and a concise analysis is generated when the emotion label indicates a stressed state.

14. The system according to claim 1, wherein the circuitry is further configured to:
compute importance scores for a plurality of text data items by applying a term frequency-inverse document frequency calculation or a natural language embedding model; and
perform a detailed analysis comprising topic extraction, intention estimation, and emotion transition analysis for text data items having importance scores exceeding a predefined threshold.

15. The system according to claim 1, wherein the circuitry is further configured to:
compute relevance scores between a plurality of text data items by calculating cosine similarities between feature vectors generated by a natural language embedding model; and
group text data items having relevance scores above a threshold into a cluster and preferentially analyze the cluster before text data items outside the cluster.

16. The system according to claim 1, wherein the circuitry is further configured to optimize parameters of an estimation algorithm by inputting a time series of past text data, past emotion scores, and past estimated intention labels into a time-series neural network, and dynamically adjusting estimation weights based on extracted patterns.

17. The system according to claim 1, wherein the circuitry is further configured to:
receive, from the client terminal, environmental audio data captured by the microphone;
input the environmental audio data into an environmental sound classification model comprising a convolutional neural network to determine a noise level and a sound source type; and
selectively suspend collection of the audio data in response to the noise level exceeding a predefined threshold.

18. A system comprising:
a communication interface comprising a communication processor and an antenna, the communication interface connected to a packet-switched network;
a processor;
a random-access memory connected to the processor;
a memory storing a speech recognition model comprising a Transformer-based neural network, an emotion identification model, and a data generation model comprising a neural network obtained by deep learning;
a database connected to the processor; and
circuitry configured to:
receive, from a client terminal via the communication interface and the packet-switched network, audio data captured by a microphone of the client terminal, the audio data comprising pulse-code modulation data sampled at 16 kHz;
convert the audio data into a spectrogram, apply noise reduction processing, and generate text data as a sequence of utterance texts by inputting the spectrogram into the speech recognition model;
generate, by inputting the text data and audio feature data comprising fundamental frequency, energy, and spectral envelope values into the emotion identification model, an emotion label selected from a plurality of predefined emotion categories and an emotion intensity score;
generate, by inputting the text data, the emotion label, and the emotion intensity score into the data generation model, inference data indicating an estimated intention, an estimation confidence score, and an estimation detail level label;
store the text data, the emotion label, the emotion intensity score, and the inference data in the database as time-series records; and
transmit, via the communication interface and the packet-switched network, the inference data to the client terminal.

19. The system according to claim 18, wherein the client terminal comprises one of a smart device comprising a touch panel and a display, smart glasses comprising a speaker and a camera, a headset-type terminal comprising a speaker, a camera, and a display, or a robot comprising a speaker, a camera, and a control target including motors.

20. A method performed by circuitry of a system, the method comprising:
receiving, from a client terminal via a packet-switched network, audio data captured by a microphone of the client terminal;
converting the audio data into text data by inputting the audio data into a speech recognition model comprising a Transformer-based neural network;
generating, by inputting the text data into an emotion identification model, an emotion label and an emotion intensity score;
generating, by inputting the text data, the emotion label, and the emotion intensity score into a data generation model comprising a neural network obtained by deep learning, inference data indicating an estimated intention; and
transmitting the inference data to the client terminal via the packet-switched network.
